(19) United States
(12) Patent Application Publication
(10) Pub. No.: US 2014/0369623 A1
(43) Pub. Date: Dec. 18, 2014

(54) Estimating phase for phase-stepping algorithms

(71) Applicant: CANON KABUSHIKI KAISHA, Tokyo (JP)

(72) Inventors: PETER ALLEINE FLETCHER, Rozelle (AU); KIERAN GERARD LARKIN, Putney (AU); DONALD JAMES BONE, Wentworth Falls (AU)

(73) Assignee: CANON KABUSHIKI KAISHA, Tokyo (JP)

(21) Appl. No.: 14/103,763

(22) Filed: Dec. 11, 2013

(30) Foreign Application Priority Data
Dec. 24, 2012 (AU) 2012268882

(51) Int. Cl. G06T 5/00; G06T 5/20

(52) U.S. Cl. CPC G06T 5/002; G06T 5/20; G06T 2207/20048; G06T 2207/10116
USPC 382/275

(57) ABSTRACT

A method of determining an actual phase offset of a fringe pattern in a captured image. A captured image, having a phase modulated fringe pattern, is one of a set of images captured with varying introduced phase offset and forms an intermediate demodulation image from the captured image. The intermediate demodulation image defines amplitude and complex phase parameters of the phase modulated fringe pattern. The captured image is transformed by a mask to produce a processed captured image having reduced effects of phase distortion. The mask is estimated from a function of at least one of the amplitude and complex phase parameters defined by the intermediate demodulation image. The method determines a Fourier transform of the processed captured image, and determines at least one phase offset of the fringe pattern in the processed captured image using the mask to identify interaction of peaks in the Fourier transform.

### REFERENCE TO RELATED PATENT APPLICATION(S)

This application claims the benefit under 35 U.S.C. §119 of the filing date of Australian Patent Application No. 2012268882, filed Dec. 24, 2012, hereby incorporated by reference in its entirety as if fully set forth herein.

### TECHNICAL FIELD

The present invention relates to the field of spatial demodulation algorithms for fringe analysis where a phase-stepping algorithm is used. In particular, this specification describes methods to assist with the demodulation of two-dimensional sets of fringes associated with an X-ray moiré device.

### BACKGROUND

Problems exist with the demodulating one or more images of fringe patterns, where each image consists of a summation of at least one sinusoidal fringes, with each fringe having a different phase in each image. Such images, and thus their fringe patterns take the form:

$${I}_{i} = {S}_{i} + A + {\sum }_{j = 1}^{k} {m}_{j} \cdot cos ( {ω}_{j} + {ϕ}_{ij} )$$

where Iᵢ is a captured two-dimensional image containing positive integer counts from some kind of digital sensor of a summation of sinusoidal fringes, with i representing an image number, 0≦i≦n, Sᵢ represents a non-sinusoidal noise image, A represents a positive intensity offset image, and j represents a fringe number, 0≦j≦k. Each fringe is represented by a positive modulation amplitude image mⱼ, a phase image ωᵢ, and a real number φᵢⱼ being a phase offset for fringe j in image i.

The images Iᵢ can be assumed to be two-dimensional for explanatory purposes, but there is no reason to limit the dimensionality, and this specification is applicable for two or more dimensions.

The fringes can be created through a variety of means, such as projected sinusoids, interference patterns of coherent sources, and moiré patterns, and such images can be composed of visible light, X-rays, audio waves or any other information else that can be imaged in two or more dimensions.

The demodulation problem is to process all of the images to determine the intensity offset image A, and the two functions mⱼ and ωⱼ for each fringe, where mⱼ is a positive, real amplitude function, and ωⱼ is the phase of a complex value. The function ωᵢ is usually determined as only the fractional part of the total number of wavelengths, i.e. modulo 2π radians, and a phase unwrapping algorithm can be used to reconstruct phases which have excursions beyond this range into a continuous function, as is well known. Phases are hereafter expressed in units of radians unless wavelength or degree units are explicitly specified.

Demodulation can be performed more accurately if all of the phase offsets of the images, φᵢⱼ, are known in advance of the demodulation algorithm.

In some systems, the phase offset φᵢⱼ between each captured image can be controlled or measured very accurately. In those systems, in which φᵢⱼ is accurately known at the time the images are taken. Demodulation is most problematic in those cases where φᵢⱼ is totally unknown, or where φᵢⱼ is close to a set of nominal values, such as 0°, 90°, 180°, 270°, but contains physical positioning errors.

Where the phase steps are nominally known and used in the demodulation algorithm, but the actual physical phase steps differ from those nominal values by as little as 0.1° due to mechanical errors in image capture, visible demodulation errors of a few percent will likely result. Depending upon the application, such errors might cause a misdiagnosis, where the imaging was being used in a medical setting, or limit the accuracy of a distance measurement beyond tolerances.

In the cases where the phase steps are not known at the time an image is taken, the phase offsets can be measured by analyzing the images, for example by using the Fourier Transform.

The Fourier Transform is a change of basis which expresses a function as the integration, or sum, of complex exponentials. The fringe patterns are constructed from the summation of real, as opposed to complex, functions, but it will be convenient to express each fringe pattern as the sum of two complex exponentials, thus (where i=\sqrt{−1}):

$$cos ( ω ) = \frac{{e}^{iω} + {e}^{- iω}}{2}$$

If the phase ω of the fringes is substantially a linear function and the amplitude is approximately constant, with w being the width of the image, h being the height of the image, and u, v being the number of wavelengths in the x, y directions respectively, then it is possible to define the two-dimensional (2D) frequency of the fringes as:

$$( {f}_{x} , {f}_{y} ) = ( \frac{ux}{w} , \frac{vy}{h} ) , \\ and$$

$$ω + {ϕ}_{0} \approx 2 π ( {f}_{x} + {f}_{y} ) + {ϕ}_{0} ,$$

From the above, it will be appreciated that the phase function φ is linear and therefore close to a single frequency. The above function can be approximately expressed:

$$a . cos ( ω + {ϕ}_{0} ) = a . \frac{{e}^{i ( ω + {ϕ}_{0} )} + {e}^{- i ( ω + {ϕ}_{0} )}}{2} \approx \frac{{e}^{i2π ( {f}_{x} + {f}_{y} ) + {ϕ}_{0}} + {e}^{- i2π ( {f}_{x} + {f}_{y} ) - {iϕ}_{0} )}}{2}$$

If each fringe in the set of fringes is linear and of constant amplitude, a Fourier transform of the sum of the fringes will contain two delta functions at each position(u, v) and (−u, −v), with a phase of φ₀ and −φ₀ respectively.

By measuring the position of each peak, the carrier frequency of each fringe pattern can be estimated, and by measuring the phase of each peak, the phase offset of each fringe pattern can be estimated. If these parameters are estimated accurately and included in the demodulation process, an accurate demodulation image can be calculated for each fringe pattern.

However, in a genuine physical system, these peaks in the Fourier domain are distorted by many effects. An image sensor usually contains discrete elements on a rectangular (x, y) grid, so that the Fourier transform is both discrete and band-limited. Thus, the peaks are not delta functions, but a discrete sampling of a sinc function. This discrete sampling results in an readily distinguishable peak when u and v are integers (that is, an integer number of wavelengths within the image), because the sampled sinc function has a maximum value at the peak position and is zero everywhere else. However, when both u and v contain fractional parts, the sine-function is non-zero at all sample positions, and decays relatively slowly, at a rate of 1/f in each of the x and y directions, and 1/f² in the diagonal directions. If the amplitude function of the fringe pattern, which is effectively a multiplication in the spatial domain, is non-constant, the peaks in the Fourier domain will be convolved with the Fourier transform of the amplitude function. The deviation of the fringes from a linear frequency results in frequency modulation, and this results in further spreading of the peaks in the Fourier domain. The values surrounding these spread peaks are called sidebands.

The combination of all of these effects is a spreading of the peaks with energy in sidebands. Where these sidebands overlap each specific peak, the apparent position (u, v) of the peak and phase offset φ₀ of the peak is perturbed. Such perturbation can result in phase offset measurement errors of a few percent, which in turn can result in errors of a few percent in demodulated amplitude and phase which are highly visible and greatly detract from the quality of the demodulated image.

The approaches discussed above have several disadvantages. One disadvantage is that if the amplitude and phase modulation of the fringe patterns are so extreme that the peak is rendered indiscernible, then in the Fourier domain the resulting sidebands which surround and distort the carrier frequency peaks will also render those peaks indiscernible.

### SUMMARY

According to one aspect of the present disclosure, there is provided a method of determining at least one actual phase offset of a fringe pattern in a captured image, said method comprising:

receiving a captured image having a phase modulated fringe pattern, the captured image being one of a set of images captured with varying introduced phase offset;

forming an intermediate demodulation image from the captured image, said intermediate demodulation image defining amplitude and complex phase parameters of the phase modulated fringe pattern;

transforming the captured image by a mask to produce a processed captured image having reduced effects of phase distortion, said mask being estimated from a function of at least one of the amplitude and complex phase parameters defined by the intermediate demodulation image;

determining a Fourier transform of the processed captured image; and

determining at least one phase offset of the fringe pattern in the processed captured image using the mask to identify interaction of peaks in the Fourier transform.

Preferably, the determining of the at least one phase offset further comprises measuring peaks in the Fourier domain.

The method may further comprise combining multiple images to estimate the peak position. Preferably the combining comprises element-wise summation of a plurality of Fourier transform images to form an image containing intensity peaks.

The mask may be a binary mask or a grey-scale mask.

According to another aspect there is provided a method of determining at least one phase offset of a fringe pattern in a captured image, said method comprising the steps of:

receiving a captured image of a phase modulated fringe pattern, the captured image being one of a set of images captured with varying introduced phase offset;

forming an intermediate demodulation image from the captured image, said intermediate demodulation image defining amplitude and complex phase parameters of the phase modulated fringe pattern;

measuring the distortion for a plurality of locations in the intermediate demodulation image;

applying a phase mask to the captured image based on the measured distortion, said phase mask defining a windowed region in the captured image having a predetermined amount of distortion; and

determining at least one phase offset of the fringe pattern in the windowed region of the captured image.

According to another aspect there is provided a method of determining at least one actual phase offset of a fringe pattern in a captured image, said method comprising:

(a) receiving a captured image having a phase modulated fringe pattern, the captured image being one of a set of images captured with varying introduced phase offset;

(b) calculating carrier frequencies of the fringe pattern;

(c) calculating (300), using a Fourier transform of the captured image and a window function, phases of the captured image;

(d) demodulating (400) from the calculated phases an intermediate demodulation image from the captured image, said intermediate demodulation image defining amplitude and complex phase parameters of the phase modulated fringe pattern including at least a phase offset value;

(e) transforming the intermediate modulation image by a mask to produce a processed captured image having reduced effects of phase distortion, said mask being estimated from a function of at least one of the amplitude and complex phase parameters defined by the intermediate demodulation image;

(f) updating the window function according to the mask; and

(g) repeating at least steps (c) and (d) at least once with the updated window function and the processed captured image to iterate a further intermediate demodulation image having an updated phase offset value, said updated phase offset value being the actual phase offset.

Other aspects are also disclosed.

### BRIEF DESCRIPTION OF THE DRAWINGS

At least one embodiment of the present invention will now be described with reference to the following drawings, in which:

FIG. 1 is a schematic block diagram showing the steps used to determine a phase offset from a phase-modulated fringe pattern;

FIG. 2 is a schematic block diagram showing the steps used to determine the carrier frequencies of at least two phase-modulated fringe patterns;

FIG. 3 is a schematic block diagram which shows the steps used to measure phase offsets from an X-ray Talbot fringe pattern image using a window function, given two carrier frequencies;

FIG. 4 is a schematic block diagram which shows the steps used to perform an initial demodulation of X-ray Talbot fringe patterns;

FIG. 5 is a schematic flow diagram which shows how a demodulation of X-ray Talbot images can be used to create mask images and a window function to be used to produce processed X-ray Talbot images;

FIG. 6 is a schematic flow diagram which shows how to measure the phase offset from a collection X-ray Talbot images by performing a trial demodulation of the images to produce a phase and amplitude image and multiplying the images by the conjugate of the phase image, and calculating one Fourier component of the result to estimate one phase offset;

FIGS. 7A and 7B form a schematic block diagram of a general purpose computer system upon which arrangements described can be practiced; and

FIG. 8 is a schematic block diagram representation of an iterative implementation according to the arrangements of FIGS. 2 to 5.

### DETAILED DESCRIPTION INCLUDING BEST MODE

### Context

An area of image processing commonly used for measurement of physical systems is fringe analysis, in which one or more images of sinusoidal fringe patterns is captured and analysed to yield amplitude and phase images of the form ae^{2πiω}, where a represents an amplitude, and ω a phase.

This process of converting between captured greyscale images and the magnitude and phase form is called demodulation. Because such demodulation is inherently ambiguous, it is common to capture several images with a different phase offset between each image, and then to use a phase stepping algorithm to demodulate the images.

The fringes can be formed by a variety of techniques, such as projection onto a surface, forming them as interference patterns between beams of coherent light, or as a moiré pattern through the interference of higher-frequency patterns. The energy which produces the fringes can be of many forms of which visible light, X-rays and sound waves are examples.

Examples of applications of the methods of fringe analysis are optical distortion measurement, measurement of surface profiles, and refraction of light rays through an object being measured, in particular by X-rays.

For reasons of improved demodulation it is common for a strong linear term to exist in the fringe patterns being analysed, and this is called a carrier frequency.

Due to mechanical imperfections and measurement errors in the apparatus used to gather the images, there may be errors in the estimates of the phase offsets and carrier frequencies, and those errors may have to be determined by analysis of the captured images.

One way to estimate these phase offsets and carrier frequencies is by analysis of the Fourier transform of the input images, in which a constant carrier frequency and the phase of the carrier frequency may be determined by finding the magnitude peak corresponding to the carrier frequency, and analysing the complex phase of the peak to determine the phase offset.

Estimating the carrier frequencies and relative phases of phase-shifted images is complicated by the distortion of these magnitude peaks by sidebands. There are several sources of sidebands, notably the sinc function caused by the combination of a rectangular window function with a non-integer number of wavelengths; the amplitude function of the carrier frequencies, and the phase modulation of the carrier frequencies.

In a phase-stepping algorithm, there are multiple images containing the fringes, and therefore a likelihood of obtaining a better estimate of the carrier frequencies by analysing all images available.

Overview

The carrier frequencies in a phase-shifted image can be estimated by finding the peaks in a Fourier transform of the fringe patterns, and the phase offset in each image by measuring the phase of the peak in the Fourier transform at each estimated frequency. However, because of the sidebands which surround each peak, such estimation is inaccurate.

When there are multiple samples of the same signal, it is possible to increase the amplitude of that signal relative to noise by summing the signal samples and taking the mean value. Summation of N samples will generally strengthen a signal by a factor of \sqrt{N} relative to noise, because the signal amplitude is multiplied by a factor of N, and the uncorrelated noise values sum to a mean amplitude \sqrt{N}.

However, with phase-shifted images, it is not possible to strengthen the signal by direct summation. Where there are multiple examples of the same signal, where each contains a different phase-shift, the summation of all of the images will cause destructive interference of the phases. As such, the relative signal amplitude will not be increased by a factor of \sqrt{N}, and the fringes may indeed disappear altogether.

The same behaviour is reflected in the Fourier transforms of the fringes, and the peaks corresponding to the carrier frequencies in the Fourier transform might also disappear in the summed images.

For example, if we have four phase-shifted images containing fringes of constant amplitude with phases of 0°, 90°, 180°, 270°, (corresponding to a complex multiplier of (1, i, −1, −i) respectively), then these fringes, neglecting the constant positive offset, will sum up thus:

$$\begin{matrix}p = ( {I}_{1} + {I}_{2} + {I}_{3} + {I}_{4} ) \\ = \frac{1}{2} ( ( {e}^{iω} + {e}^{- iω} ) + ( {e}^{i ( ω + π \text{/} 2 )} + {e}^{- i ( ω + π \text{/} 2 )} ) + ( {e}^{i ( ω + π )} + {e}^{- i ( ω + π )} ) + \\ ( {e}^{i ( ω - π / 2 )} + {e}^{- i ( ω - π \text{/} 2 )} ) ) \\ = \frac{1}{2} ( ( {e}^{iω} + {e}^{- iω} ) + i . ( {e}^{iω} + {e}^{- iω} ) - ( {e}^{iω} + {e}^{- iω} ) - \\ i ( {e}^{iω} + {e}^{- iω} ) ) \\ = 0\end{matrix}$$

If the phase step is known for each image, even approximately, then each peak value may be multiplied by the conjugate of the known phase steps so that the peaks sum coherently:

$$\begin{matrix}R = ( {I}_{1} + i . {I}_{2} - {I}_{3} - i . {I}_{4} ) \\ = \frac{1}{2} ( ( {e}^{iω} + {e}^{- iω} ) - i . ( {e}^{i ( ω + π \text{/} 2 )} + {e}^{- i ( ω + π \text{/} 2 )} ) - ( {e}^{i ( ω + π )} + {e}^{- i ( ω + π )} ) + \\ i . ( {e}^{i ( ω - π \text{/} 2 )} + {e}^{- i ( ω - π \text{/} 2 )} ) ) \\ = \frac{1}{2} ( ( {e}^{iω} + {e}^{- iω} ) - i . ( i . {e}^{iω} - i . {e}^{- iω} ) - ( - {e}^{iω} + {e}^{- iω} ) + \\ i . ( - i . {e}^{iω} + i . {e}^{- iω} ) ) \\ = \frac{1}{2} ( {e}^{iω} + {e}^{- iω} + {e}^{iω} - {e}^{- iω} + {e}^{iω} + {e}^{- iω} + {e}^{iω} - {e}^{- iω} ) \\ = 2 {e}^{iω}\end{matrix}$$

Because the energy in e^{iω} is double that of a real sinusoid, the total amplitude of the carrier frequency in this method will be increased by a factor of 4, and the signal-to-noise-ratio (SNR) by a factor of 2. Note that even if the phase shift of each image is not known exactly, this process will reinforce peaks more strongly than the noise.

There is also sideband interference in each image coming from the sidebands of carrier frequencies in the image. In many arrangements of 2D phase-stepping images, it can also be arranged that the summation of the phase-shifted sidebands will cancel out, for one carrier at a time at least.

In the case that the phase of the input images is not known, summing the intensities of the Fourier transforms, i.e. |F|², will produce a summation in which the peak amplitude is improved relative to the noise, i.e.

\sqrt{|F(I₁)|²+|F(I₂)|²+|F(I₃)|²+|F(I₄)|²}

However, the process of calculating the intensity by squaring, or, equivalently, calculating |FF*| (where * is complex conjugation), causes frequency doubling of the FourierTransform signal, and, hence, aliasing.

Experience has shown that any amount of aliasing introduces a significant amount of bias into peak position estimation, and hence frequency estimation, and is therefore highly undesirable. Later we describe how carrier frequencies can be removed without aliasing.

The sidebands which surround carrier frequencies are composed of contributions from many different components of the image signal. These components include: a summation of sinc functions surrounding each of the carrier frequencies, including the DC value, due to the rectangular window of the image; a summation of the sidebands surrounding the carrier frequencies, including DC, due to multiplication of the image by the absorption signal a; and a summation of the sidebands surrounding each of the carrier frequencies due to the phase modulation of that carrier frequency.

The error contributed by the sinc functions surrounding each peak can be removed by constructing and solving a system of linear equations of the form

pᵢ=Σⱼ₌₁ⁿzⱼsinc(pᵢₓ−pⱼₓ,p_{iy}−p_{jy}),

where pᵢ is the complex measured value of peak i, zⱼ is the unknown underlying complex peak values to be solved for which matches the initial conditions, and peak i is at position (pᵢₓ, p_{iy}). The solutions for zⱼ represent the phase and amplitude of a set of delta functions which would produce the measured phases in the Fourier transform, and, if the sidebands introduced by the rectangular window function were the only source of error in the measurement, then the solutions would represent a consistent solution for the phase of each carrier frequency.

The absorption effect, in which the light in the image is attenuated by the sample, is equivalent to an image multiplication. A correction for the absorption effect can be incorporated into the correction for the rectangular window by instead of calculating a sinc function, calculating the function corresponding to the rectangular absorption image instead, and using the values of this function in the system of linear equations as given.

The phase modulation and the modulation amplitude effects are more difficult to model, because they affect each carrier frequency in a different way.

One possible way to address this can be found by noting that most images under analysis consist of edges, textured regions, and relatively unmodulated regions. If the whole image were relatively unmodulated, only the sinc and the absorption sidebands would need to be taken into account. In an image with a mixture of relatively modulated and unmodulated regions, it would be convenient if it were possible to use only the relatively unmodulated regions of the image for frequency and phase estimation, or, alternatively, to remove the modulation.

From a demodulated image, it is possible to estimate frequency and phase by analysing the demodulated amplitude, demodulated phase, and modulation strength derived during the demodulation process, as will be shown later.

If, by analysing the image, areas of strong modulation could be detected, then a mask image, of the same size as the input images and containing values between 0 and 1, can be created to de-weight these regions from analysis. Such a mask image could be used to supplement the windowed absorption function, with the mask image containing low values in the regions where phase or amplitude modulation was the strongest.

To use this mask image, each of the phase-shifted images is multiplied by the mask image to de-emphasize areas of strongly modulated phase. An estimate of the amplitude image, used to calculate the sidebands, is also multiplied by the mask image to yield a masked amplitude function. After these steps, the Fourier transform of each phase-shifted image is calculated, the phases measured, and the corrected phases modelled using the Fourier transform of the masked amplitude function.

By multiplying input images with the mask image, and also the rectangular absorption window used to calculate side-bands, strongly modulated areas of the input image can be removed from analysis, making it possible to calculate frequency and phase offsets more accurately.

To estimate the correct carrier frequencies, the underlying phase function, and the amplitude function, the presently disclosed method requires an estimation of the demodulated images. If a demodulated image could be created which is an approximation of the properly demodulated image, an approximation to the mask could be created.

The frequencies and phase offsets of the input images can be estimated by measurement of peaks and modelling of sidebands. While inaccurate, these parameters can be input to a demodulation algorithm, to give a trial demodulation image, which may also be called an “intermediate demodulation image”, consisting of at least absorption and phase estimates for each pixel.

Examination of this trial demodulation image can allow a mask image to be generated as described, which then may be applied to each input image. During the modelling process, the trail demodulation image may be used to estimate the frequency, amplitude and phases of the input image carrier frequencies.

Where the phase modulation is large over the whole sensor area, it is possible that no well-defined peak, except the DC peak, will be visible in the Fourier transform. In this case, presently disclosed are techniques to shift the distributed frequencies of a fringe pattern towards a single frequency, or into the DC position of the Fourier transform, to the extent that a discernible peak is formed at a known position. From this single frequency, a phase offset can accurately be measured. This technique has been termed carrier compression by the present inventors.

As seen above, a single real fringe pattern with phase offset φ₀ can be regarded as the sum of a complex fringe pattern with its conjugate:

$$cos ( ω + {ϕ}_{0} ) = \frac{{e}^{i ( ω + {ϕ}_{0} )} + {e}^{- i ( ω + {ϕ}_{0} )}}{2}$$

If an estimate exists for ω, then multiplying the image by e^{-iω} yields this result:

$$\begin{matrix}{e}^{- iω} . cos ( ω + {ϕ}_{0} ) = {e}^{- iω} \cdot ( \frac{{e}^{i ( ω + {ϕ}_{0} )} + {e}^{- i ( ω + {ϕ}_{0} )}}{2} ) \\ = \frac{{e}^{{iϕ}_{0}}}{2} + \frac{{e}^{- i ( 2 ω + {ϕ}_{0} )}}{2}\end{matrix}$$

In some implementations according to the present disclosure, the phase offset of an analysed carrier represents a phase difference between a predetermined carrier and the analysed carrier. In alternative implementations, the phase offset refers to a phase difference between an arbitrary chosen carrier and the analysed carrier, and may be referred as “phase shift”. Note that the term e^{iφ}^{₀} is a constant value, and that the frequency of the terms, e^{-i(2ω+φ}^{₀}⁾, are doubled. The Fourier transform of this image will consist of the sum of these two parts. Being a constant term, e^{iφ}^{₀} will result in a strong peak at the DC position of the Fourier transform, with the amplitude of the peak representing the amplitude of the carrier frequency in the image, and the phase being the phase step desired to be established. The second part, e^{-i(2ω+φ}^{₀}⁾, is a frequency-doubled version of the original signal. As established above, since there is no strong peak in the original signal, the frequency-doubled signal will be even wider than the original signal, and should not substantially interfere with the DC peak.

If there is more than one fringe pattern in the image, the other fringes, and the substantial DC peak, can be substantially filtered out by spatial band-pass filter before the multiplication. However, as the DC and other fringe peaks are spread out by the multiplication anyway, they might not cause substantial interference in the original signal, and their overlap of the DC position is not likely to perturb the estimate substantially.

Note also that because the term e^{iφ}^{₀}, is a constant value, such will result in a strong peak at the DC position of a Fourier transform of the multiplied images, the peak having a phase of φ₀. This value can be calculated directly from the multiplied image, being the complex mean of the multiplied image, therefore no Fourier transform operation is necessary to evaluate the DC peak having phase φ₀.

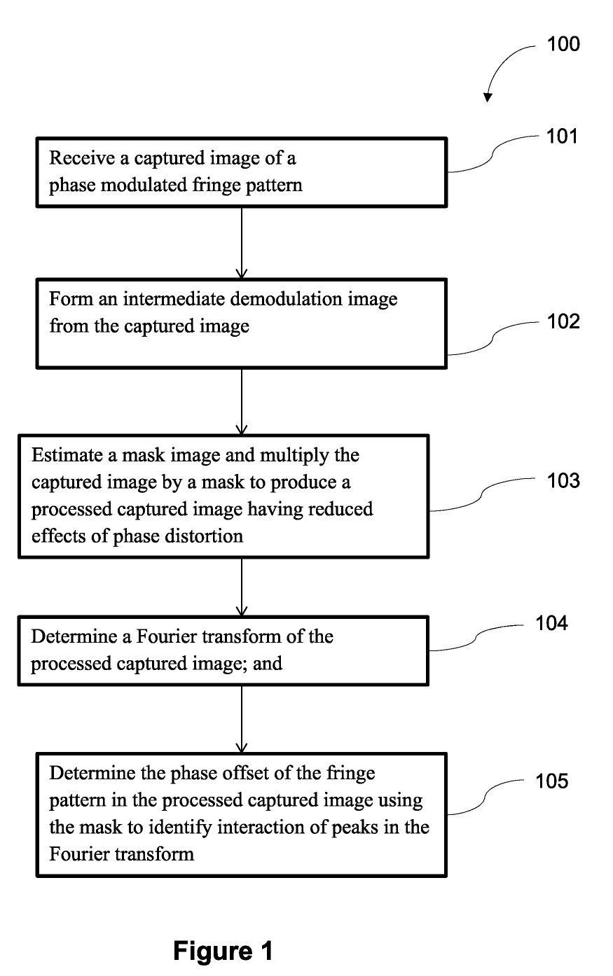

FIG. 1 summarizes a method 100 of determining at least one actual phase offset of a fringe pattern in a captured image.

In a first step 101, an image having a phase-modulated fringe pattern is captured by an imaging device. This step may in fact be performed by capturing a number of fringe pattern images at different applied or introduced phase offsets and selecting one of those captured images for subsequent processing.

In step 102, the fringe pattern is demodulated from the single-phase modulated fringe pattern image, to yield an approximations of an amplitude image a and a phase image ω. These two images collectively form an intermediate demodulation image derived from the captured image.

In step 103, a mask image is estimated from the amplitude image a and the phase image ω. The fringe pattern image is then multiplied by the mask, resulting in processed fringe pattern image.

In step 104, at least one Fourier transform component is determined of the processed fringe pattern image. Typically this step involves forming a Fourier transform image from the processed fringe pattern image.

In step 105, at least one phase offset of the fringe pattern is estimated. This is desirably performed using the mask image to identify an interaction of peaks in the Fourier transform image.

For some applications, the phase distortion of all fringe patterns is directly inter-convertible into a vector field defining a spatial distortion, or warp map. Note that a linear sinusoid may only be distorted in the direction of the phase gradient. For example, horizontal fringes cannot be distorted by a warp which is purely in the X direction, and are maximally distorted by a warp which is purely in the Y direction, and are only somewhat distorted by warps in a direction in between. Where a carrier frequency is present, that carrier frequency must first be removed from the phase function by subtracting a linear ramp. Also, where the spatial distortion is large, the phase might need to be unwrapped to produce a continuous function representing the warp.

Because any given fringe pattern will only be changed by spatial distortions with a component in the direction of the phase gradient, it is necessary to have at least two fringe patterns to derive a two-dimensional spatial distortion. When there are two fringe patterns, they should ideally be arranged to be orthogonal to each other, and where there are more than two, they should be chosen to be widely separated both in direction and in the frequency domain.

If a spatial warp can be derived from at least two trial demodulation images, then that spatial warp can be inverted and applied to each of the fringe patterns in the set of images, thus returning each image to be close to linear fringes. Each of these linearized fringe patterns may then be processed as described earlier using a Fourier transform to derive a phase offset for each image and each fringe pattern.

### Physical Implementation

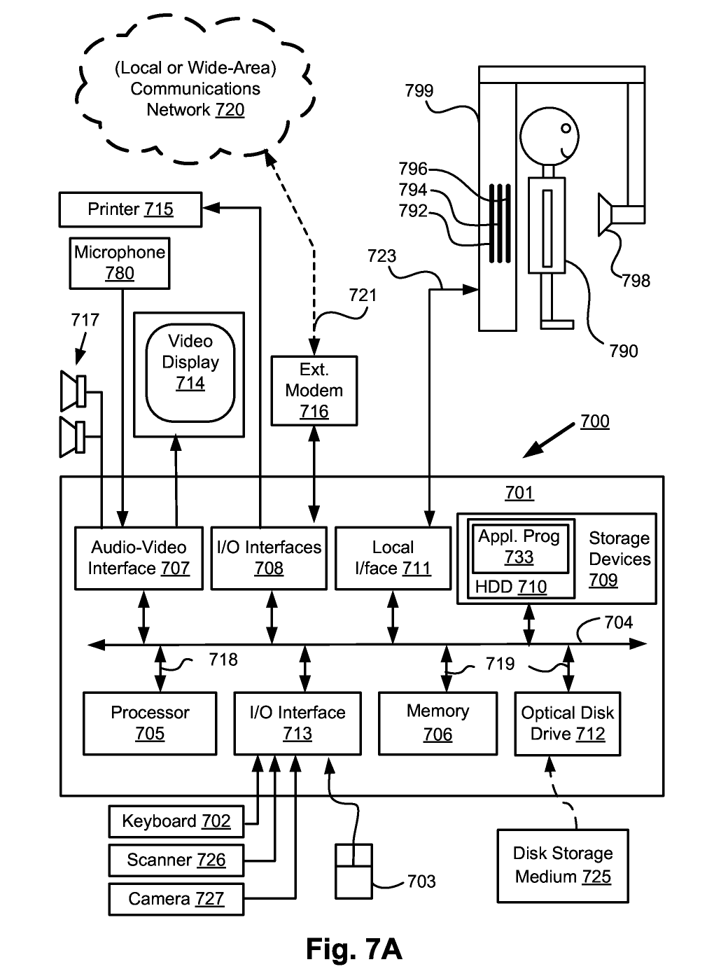

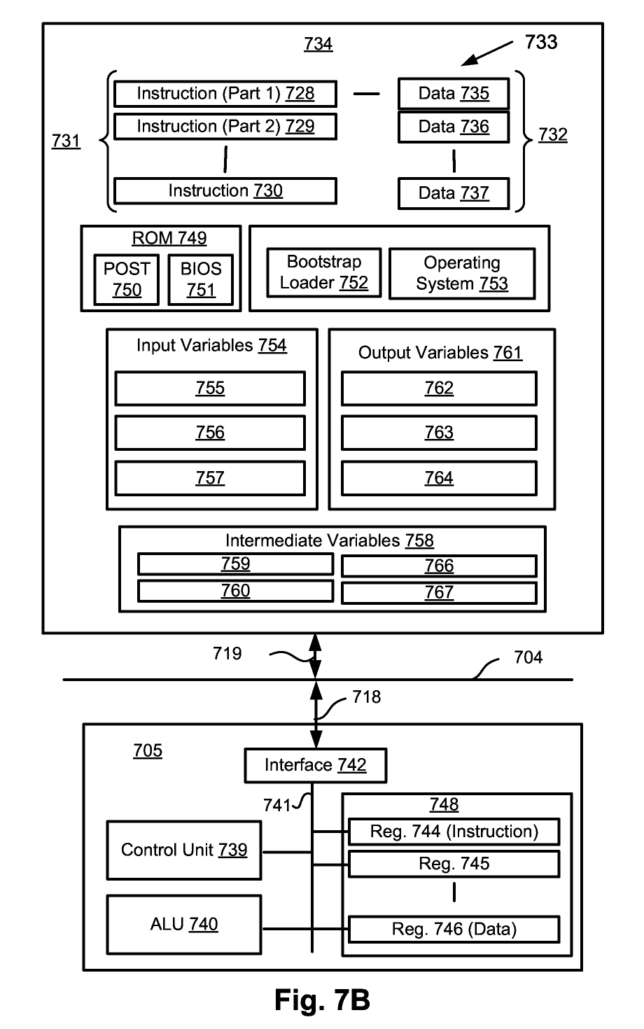

FIGS. 7A and 7B depict a general-purpose computer system 700, upon which the various arrangements described can be practiced.

As seen in FIG. 7A, the computer system 700 includes: a computer module 701; input devices such as a keyboard 702, a mouse pointer device 703, a scanner 726, a camera 727, and a microphone 780; and output devices including a printer 715, a display device 714 and loudspeakers 717. In this example, the computer module 701 is also shown coupled via a connection 723 to an X-ray apparatus 799, configured for the capture of X-ray Talbot interferometry (XTI) images.

The X-ray apparatus 799 includes a source 798 of partially-coherent x-rays for imaging an object 790. A phase grating G1 (796), positioned behind the object 790, and the object 790 being imaged, are both illuminated by X-rays and a self-image (not illustrated) is formed at a position behind the phase grating 796 due to the Talbot effect. Since the phase of the X-ray wave is perturbed by the object 402, the self-image 420 is deformed. By analysing the deformed self-image, the characteristics of the object 402 can be deduced. An absorption grating G2 (794) is placed at the position of the self-image to generate a moiré fringe pattern. An image sensor 792 is proximate to the absorption grating 794 and configured to capture the moiré fringe pattern. Not illustrated is a mechanism within the X-ray apparatus 799 by which the relative positions of at least two of the phase grating 796, the absorption grating 794 and the source, may be varied. This permits, for each variation (being an introduced phase step or offset), the capture of a corresponding fringe pattern image by the sensor 792.

An external Modulator-Demodulator (Modem) transceiver device 716 may be used by the computer module 701 for communicating to and from a communications network 720 via a connection 721. The communications network 720 may be a wide-area network (WAN), such as the Internet, a cellular telecommunications network, a private WAN, or a local-area-network (LAN). Where the connection 721 is a telephone line, the modem 716 may be a traditional “dial-up” modem. Alternatively, where the connection 721 is a high capacity (e.g., cable) connection, the modem 716 may be a broadband modem. A wireless modem may also be used for wireless connection to the communications network 720. The network 720 may represent an alternate source of fringe pattern images for processing, and/or a destination for processed images.

The computer module 701 typically includes at least one processor unit 705, and a memory unit 706. For example, the memory unit 706 may have semiconductor random access memory (RAM) and semiconductor read only memory (ROM). The computer module 701 also includes an number of input/output (I/O) interfaces including: an audio-video interface 707 that couples to the video display 714, loudspeakers 717 and microphone 780; an I/O interface 77 that couples to the keyboard 702, mouse 703, scanner 726, camera 727 and optionally a joystick or other human interface device (not illustrated); and an interface 708 for the external modem 716 and printer 715. In some implementations, the modem 716 may be incorporated within the computer module 701, for example within the interface 708. The computer module 701 also has a local interface 711, which permits coupling of the computer system 700 via the connection 723 to the X-ray apparatus 799. The interfaces 708 and 711 may be configured to operate on respective standards, such as Ethernet™, a Bluetooth™ wireless arrangement or an IEEE 802.11 wireless arrangement; however, numerous other types of interfaces may be practiced. The connection 723 is typically bidirectional enabling automated X-ray image capture by the apparatus 799 under direction of the computer 701 and for the communication of captured image data to the computer 701 for storage in the memory 706 or HDD 710.

The I/O interfaces 708 and 713 may afford either or both of serial and parallel connectivity, the former typically being implemented according to the Universal Serial Bus (USB) standards and having corresponding USB connectors (not illustrated). Storage devices 709 are provided and typically include a hard disk drive (HDD) 710. Other storage devices such as a floppy disk drive and a magnetic tape drive (not illustrated) may also be used. An optical disk drive 712 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 700.

The components 705 to 713 of the computer module 701 typically communicate via an interconnected bus 704 and in a manner that results in a conventional mode of operation of the computer system 700 known to those in the relevant art. For example, the processor 705 is coupled to the system bus 704 using a connection 718. Likewise, the memory 706 and optical disk drive 712 are coupled to the system bus 704 by connections 719. Examples of computers on which the described arrangements can be practised include IBM-PC's and compatibles, Sun Sparcstations, Apple Mac™ or a like computer systems.

The methods of phase offset determination may be implemented using the computer system 700 wherein the processes of FIGS. 1 to 6, to be described, may be implemented as one or more software application programs 733 executable within the computer system 700. In particular, the steps of the methods of phase offset determination are effected by instructions 731 (see FIG. 7B) in the software 733 that are carried out within the computer system 700. The software instructions 731 may be formed as one or more code modules, each for performing one or more particular tasks. The software may also be divided into two separate parts, in which a first part and the corresponding code modules performs the phase offset determination methods and a second part and the corresponding code modules manage a user interface between the first part and the user.

The software may be stored in a computer readable medium, including the storage devices described below, for example. The software is loaded into the computer system 700 from the computer readable medium, and then executed by the computer system 700. A computer readable medium having such software or computer program recorded on the computer readable medium is a computer program product. The use of the computer program product in the computer system 700 preferably effects an advantageous apparatus for X-ray imaging and image processing, particularly for phase offset determination of interferogram fringe patterns.

The software 733 is typically stored in the HDD 710 or the memory 706. The software is loaded into the computer system 700 from a computer readable medium, and executed by the computer system 700. Thus, for example, the software 733 may be stored on an optically readable disk storage medium (e.g., CD-ROM) 725 that is read by the optical disk drive 712. A computer readable medium having such software or computer program recorded on it is a computer program product. The use of the computer program product in the computer system 700 preferably effects an apparatus for X-ray imaging and image processing, particularly for phase offset determination of interferogram fringe patterns.

In some instances, the application programs 733 may be supplied to the user encoded on one or more CD-ROMs 725 and read via the corresponding drive 712, or alternatively may be read by the user from the network 720. Still further, the software can also be loaded into the computer system 700 from other computer readable media. Computer readable storage media refers to any non-transitory tangible storage medium that provides recorded instructions and/or data to the computer system 700 for execution and/or processing. Examples of such storage media include floppy disks, magnetic tape, CD-ROM, DVD, Blu-ray Disc™, a hard disk drive, a ROM or integrated circuit, USB memory, a magneto-optical disk, or a computer readable card such as a PCMCIA card and the like, whether or not such devices are internal or external of the computer module 701. Examples of transitory or non-tangible computer readable transmission media that may also participate in the provision of software, application programs, instructions and/or data to the computer module 701 include radio or infra-red transmission channels as well as a network connection to another computer or networked device, and the Internet or Intranets including e-mail transmissions and information recorded on Websites and the like.

The second part of the application programs 733 and the corresponding code modules mentioned above may be executed to implement one or more graphical user interfaces (GUIs) to be rendered or otherwise represented upon the display 714. Through manipulation of typically the keyboard 702 and the mouse 703, a user of the computer system 700 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 717 and user voice commands input via the microphone 780.

FIG. 7B is a detailed schematic block diagram of the processor 705 and a “memory” 734. The memory 734 represents a logical aggregation of all the memory modules (including the HDD 709 and semiconductor memory 706) that can be accessed by the computer module 701 in FIG. 7A.

When the computer module 701 is initially powered up, a power-on self-test (POST) program 750 executes. The POST program 750 is typically stored in a ROM 749 of the semiconductor memory 706 of FIG. 7A. A hardware device such as the ROM 749 storing software is sometimes referred to as firmware. The POST program 750 examines hardware within the computer module 701 to ensure proper functioning and typically checks the processor 705, the memory 734 (709, 706), and a basic input-output systems software (BIOS) module 751, also typically stored in the ROM 749, for correct operation. Once the POST program 750 has run successfully, the BIOS 751 activates the hard disk drive 710 of FIG. 7A. Activation of the hard disk drive 710 causes a bootstrap loader program 752 that is resident on the hard disk drive 710 to execute via the processor 705. This loads an operating system 753 into the RAM memory 706, upon which the operating system 753 commences operation. The operating system 753 is a system level application, executable by the processor 705, to fulfil various high level functions, including processor management, memory management, device management, storage management, software application interface, and generic user interface.

The operating system 753 manages the memory 734 (709, 706) to ensure that each process or application running on the computer module 701 has sufficient memory in which to execute without colliding with memory allocated to another process. Furthermore, the different types of memory available in the system 700 of FIG. 7A must be used properly so that each process can run effectively. Accordingly, the aggregated memory 734 is not intended to illustrate how particular segments of memory are allocated (unless otherwise stated), but rather to provide a general view of the memory accessible by the computer system 700 and how such is used.

As shown in FIG. 7B, the processor 705 includes a number of functional modules including a control unit 739, an arithmetic logic unit (ALU) 740, and a local or internal memory 748, sometimes called a cache memory. The cache memory 748 typically includes a number of storage registers 744-746 in a register section. One or more internal busses 741 functionally interconnect these functional modules. The processor 705 typically also has one or more interfaces 742 for communicating with external devices via the system bus 704, using a connection 718. The memory 734 is coupled to the bus 704 using a connection 719.

The application program 733 includes a sequence of instructions 731 that may include conditional branch and loop instructions. The program 733 may also include data 732 which is used in execution of the program 733. The instructions 731 and the data 732 are stored in memory locations 728, 729, 730 and 735, 736, 737, respectively. Depending upon the relative size of the instructions 731 and the memory locations 728-730, a particular instruction may be stored in a single memory location as depicted by the instruction shown in the memory location 730. Alternately, an instruction may be segmented into a number of parts each of which is stored in a separate memory location, as depicted by the instruction segments shown in the memory locations 728 and 729.

In general, the processor 705 is given a set of instructions which are executed therein. The processor 705 waits for a subsequent input, to which the processor 705 reacts to by executing another set of instructions. Each input may be provided from one or more of a number of sources, including data generated by one or more of the input devices 702, 703, data received from an external source across one of the networks 720, 702, data retrieved from one of the storage devices 706, 709 or data retrieved from a storage medium 725 inserted into the corresponding reader 712, all depicted in FIG. 7A. The execution of a set of the instructions may in some cases result in output of data. Execution may also involve storing data or variables to the memory 734.

The disclosed image processing arrangements use input variables 754, which are stored in the memory 734 in corresponding memory locations 755, 756, 757. The image processing arrangements produce output variables 761, which are stored in the memory 734 in corresponding memory locations 762, 763, 764. Intermediate variables 758 may be stored in memory locations 759, 760, 766 and 767.

Referring to the processor 705 of FIG. 7B, the registers 744, 745, 746, the arithmetic logic unit (ALU) 740, and the control unit 739 work together to perform sequences of micro-operations needed to perform “fetch, decode, and execute” cycles for every instruction in the instruction set making up the program 733. Each fetch, decode, and execute cycle comprises:

(i) a fetch operation, which fetches or reads an instruction 731 from a memory location 728, 729, 730;

(ii) a decode operation in which the control unit 739 determines which instruction has been fetched; and

(iii) an execute operation in which the control unit 739 and/or the ALU 740 execute the instruction.

Thereafter, a further fetch, decode, and execute cycle for the next instruction may be executed. Similarly, a store cycle may be performed by which the control unit 739 stores or writes a value to a memory location 732.

Each step or sub-process in the processes of FIGS. 1 to 6 is associated with one or more segments of the program 733 and is performed by the register section 744, 745, 747, the ALU 740, and the control unit 739 in the processor 705 working together to perform the fetch, decode, and execute cycles for every instruction in the instruction set for the noted segments of the program 733.

The methods of image processing may alternatively be implemented in whole or part using dedicated hardware such as one or more integrated circuits performing the functions or sub functions of image processing. Such dedicated hardware may include graphic processors, digital signal processors, or one or more microprocessors and associated memories. For example such devices may be used to accelerate processing of Fourier transforms and the like, to be described.

### Example 1

X-ray imaging is widely used in medical applications to obtain a view inside the human body. X-rays have a very short wavelength, in the range from 0.01 to 10 nm, and greater penetrating power than visible light, which has a wavelength varying between 380 and 760 nm.

Most X-ray imaging applications rely on the fact that different materials absorb X-rays to differing extents. When an object, for example, part of the human body, is placed between an X-ray source and an X-ray image sensor, each sensor element will image X-rays projected in a straight line through the object, and attenuated by absorption by the materials intersected by that line. All the sensor elements together will represent a grid of projected lines, and will show a spatial representation of the internal structure of the object.

The X-ray beam can either be generated by a synchrotron, or by directing an electron beam at a metal target. As the synchrotron is very large and very expensive, most medical X-ray devices use an electron beam to generate the X-rays.

Varying the voltage of the electron beam will correspondingly vary the energy of the emitted electrons, and the X-ray beam produced will have a broad spectrum with energy increasing with frequency up to a maximum frequency corresponding to the energy of the electrons. The spectrum also contains emission peaks at the characteristic lines corresponding to the energy transitions of electrons in the inner shells of the metal in the target.

Aside from the X-ray source, digital X-ray imaging equipment also includes a digital sensor, which usually is formed of a scintillator, which is a screen that converts X-rays into visible light, and a visible-light image sensor, which is similar to a normal CCD or CMOS sensor, such as typically found in a digital camera.

Because it is extremely difficult to refract, focus or reflect X-rays to any substantial extent, the optical path in most imaging systems is usually from a point-like source in the X-ray tube fanning out in linear beams which pass through the object and then impinge upon the sensor, rather like shadows.

Aside from absorbing X-rays, an object will often contain materials of different refractive indices, and will hence also deflect the X-rays to some extent. Refractive indices associated with X-rays are generally close to 1.0, so that such deflection is also very tiny, on the level of microns, over the approximately human scale of source and detector.

Although such tiny deflections are not directly visible on the X-ray sensor, it is possible to cause those deflections to be visible by using an arrangement of gratings which produce a moiré effect. One such arrangement is outlined here, and involves three gratings: G0, G1, and G2.

The first grating, G0, contains a grid of pinholes, and is used to create many partially-coherent beams of X-rays. The grating G0 is not illustrated in FIG. 7A, but is usually positioned between the source 798 and subject 790 at a position immediately adjacent the X-ray source 798.

The second grating, G1, contains a chequerboard of silicon squares interspersed with holes. The thickness of the silicon causes a retardation in the phase of the X-ray beam by approximately π radians, resulting in a chequerboard of beams with phases of 0 and π radians, with a typical cell pitch of approximately 4μ. That phase offset in turn results in an amplitude modulation of the X-rays with a period equal to one of the squares of the chequerboard.

These modulated X-ray beams pass through the object, and are deflected and absorbed according to the object's respective refractive index and absorption. Through the Talbot effect, the X-ray beams are reconstructed as a chequerboard amplitude at the final grating.

Because the X-ray beam emanates from a point-like source, the X-rays are not collinear, but spread out in a fan beam.

The final grating, G2, is an amplitude grating made of gold, which blocks X-rays, interspersed with silicon-filled holes, through which X-rays can be transmitted. The G2 grating may be positioned by rotation, translation, and shifting along the Z-axis relative to the G1 grating to produce a moiré pattern of a sufficiently low frequency to be detected by the X-ray image sensor.

The G1 grating forms a pattern of X-ray beams in the form of a square grid, with a Fourier transform containing frequencies corresponding to the pitch of the grating cells of approximately 4μ.

The Fourier transform contains only the fundamental harmonics of the grid pattern in the Fourier transform, corresponding to 9 frequencies arranged in a square grid, with the central frequency being the DC (zero) frequency.

The frequency of each of the 8 non-zero frequencies is much higher than the spacing of a CCD cell in the X-ray sensor 792, so these frequencies cannot be well-detected. When the X-ray beams impinge upon an object 790 being imaged, the 4 μm beams are attenuated by the object 790, and deflected slightly, by an amount of the same order as the beam width, through refraction.

This amplitude and phase modulation caused by the deflection has the effect of spreading the 9 peaks in the Fourier transform of the beam pattern.

If we assume that the G1 grating is aligned with the CCD sensor 792, then the deflections of the beams in the x and y direction will be reflected in the x and y frequencies of the grid pattern respectively, and the cross-frequencies will contain the deflections in the direction of (x+y) and (x−y). It is not necessary to align the G1 grating 796 with the sensor 792, but it is convenient in the following explanation to assume that both are aligned.

When the beams subsequently impinge upon the amplitude grating, G2 794, the impinging beams are blocked in a grid pattern, which creates a moiré interference pattern. This blocking of beams can be modelled as a multiplication of the beam pattern by the grid pattern. In the Fourier domain, this is equivalent to a convolution of the G1 beam pattern by the G2 grid pattern.

Both the G1 and the G2 patterns are square grids with Fourier transforms consisting of 9 peaks, with eight of them at high frequencies.

If the G2 grating 794 is appropriately rotated and/or shifted in the Z direction with respect to the G1 grating 796, this convolution has the effect of shifting each one of the high frequencies down to a lower frequency, which can in turn be detected by a CCD sensor (792) with a sensor pitch of a much larger scale than the beam pitch, for example of 48 μm.

The moiré pattern will approximately take the form:

$${z}_{i} = \frac{1}{4} a ( 1 + {m}_{x} cos ( {ω}_{x} + {ϕ}_{xi} ) ) ( 1 + {m}_{y} cos ( {ω}_{y} + {ϕ}_{yi} ) ) \qquad ( 1 )$$

where

zᵢ is an intensity of an image received upon the image sensor 792 for image number i, from a total of n images,

a is the attenuation function of the object, and is between 0 and 1,

mₓ and m_{y} are an image modulation strengths of the cosine component of the moiré pattern,

ωₓ and ω_{y} are phase functions related to the moire patterns, in units of cycles, and

φₓᵢ and φ_{yi} are real values representing the global phase offsets of the x and y fringes in each image.

Neglected in this equation is the effect of the modulation transfer function (MTF) and nonlinearities of the system caused by the pinholes, mask, scintillator and pixel sensor.

Each image contains a pair of fringes, at an angle of 90° to each other and combined by multiplication. One fringe incorporates an optical path-length derivative primarily in the x direction, and the other fringe an optical path-length derivative primarily in the y direction, although the fringe pair can be at any orientation with respect to these derivatives.

The optical path length is the integral of the refractive index along the refracted path from the X-ray beam source to the sensor, and in an area over which it is constant, the X-ray beams emanating from the G1 grating will create a moiré pattern on the sensor without any phase offset. In a region where the refractive index or the object thickness changes, the deflection of the X-ray beams will be changing, and a phase offset will be reflected in the moiré pattern in that position. The moiré pattern fringes hence represent the derivative of the optical path length.

The phases containing either the derivatives can be interpreted as containing several parts:

$${ω}_{x} = 2 π ( {xf}_{x} + {yf}_{y} + \frac{\partial ψ}{\partial x} )$$

$${ω}_{y} = 2 π ( {xf}_{y} - {yf}_{x} + \frac{\partial ψ}{\partial y} )$$

\tilde{F}ₓ=(fₓ,f_{y}) and \tilde{F}_{y}=(f_{y},−fₓ) are the two underlying orthogonal two-dimensional frequencies of the moire carriers, called the carrier frequencies, and

$$\frac{\partial ψ}{\partial x} and \frac{\partial ψ}{\partial y}$$

are the derivatives of the optical path length along the x and the y directions respectively. Note that the directions of the fringes forming the carrier frequencies are independent of the optical path length derivative represented by those fringes. Depending upon the physical arrangement of the equipment, \tilde{F}ₓ and \tilde{F}_{y} may or may not be known.

This moiré pattern contains multiple overlapping sinusoidal frequencies which encode the phase modulation due to the refraction of the X-rays by the object. However, in any phase-modulated image, it is difficult to disentangle the phase- and amplitude-modulation effects. This problem is compounded where the carrier frequencies are multiplied together, because frequency components will be produced at sum and difference frequencies of the two fringes. Consider for example,

$$cos {f}_{x} \times cos {f}_{y} = \frac{1}{2} ( cos ( {f}_{x} - {f}_{y} ) + cos ( {f}_{x} + {f}_{y} ) ) .$$

For purposes of the present disclosure, the frequencies fₓ−f_{y} and fₓ+f_{y} are called cross terms.

The process of demodulation with the X-ray moiré is in fact more complicated than was described earlier, because the demodulation process must take account of the cross-terms. However, the process will still take as input the set of phase-shifted images, and the measured relative phases of the two fringe patterns in each image.

The demodulation problem with these X-ray Talbot images is to take a set of images [I₁ . . . Iₙ] in some phase-shifted arrangement, and their associated phase-offsets, [φₓ₁ . . . φₓₙ] and [φ_{y1} . . . φ_{yn}], and derive each of the five parameters a, mₓ, m_{y} and ωₓ, ω_{y} per pixel. The parameters therefore each form a respective processed image.

Each parameter has a physical interpretation, and can be used as an aid to the interpretation of the object under analysis. a is an image containing the absorption factor of the object being imaged located before G1 and G2, with a value of 1 being full transmission (e.g. there is no object present), and 0 being full absorption (e.g. a completely X-ray opaque object), and it is approximately proportional to the inverse exponential of the density of the object integrated between the source 798 and the sensor 792, being a∝e^{-d}. The image a closely corresponds to the image as observed in a conventional X-ray. mₓ and m_{y} are images representing the modulation strength of the moiré pattern, which, with a simple physical model, could be regarded as constant, but in reality are affected by many physical factors of the object and the equipment, and will contain values between 0 and 1. ωₓ and ω_{y} are phase factors which contain a linear term that corresponds to the set-up of the moiré pattern, but also contain a component representative of the optical path length of the X-rays, and therefore representative of the refraction by the object. It is these phase factors which are most important in distinguishing this imaging method from conventional X-ray imaging.

In a preferred implementation the five parameters are determined by capturing and analysing multiple images. During the capture process, the phases of the cosine terms are offset by separate constant factors for each image. In the case of the X-ray images, this is achieved by physically shifting the grating by a fraction of a wavelength. After the images containing phase offsets have been captured, they are analysed by a phase-shifting algorithm which produces the five parameters as a result for each pixel.

One such a phase-shifting algorithm, which requires eight specific sets of phase offsets in a chequerboard arrangement, is described in the second implementation. Other algorithms using various numbers of images and patterns of phase offset are well known in the prior art.

A common property of many of these algorithms is that they require the relative phases of the different phase-shifted images to be known, either because the phase offsets used are fixed as a property of the algorithm, or because the algorithm requires the phase offsets to be input as parameters to the algorithm.

After demodulation, the derived phase functions ωₓ and ω_{y} may still contain an unknown constant phase offset φₓ⁰ and φ_{y}⁰ if the original phase offset was not calibrated to a known position, and linear phase functions with frequencies (\tilde{F}ₓ and \tilde{F}_{y}). If the underlying carrier frequencies are already known, they can be removed by subtracting the appropriate linear ramp from the phase, or, equivalently, multiplying the phase function with the conjugate linear phase function. Otherwise, the underlying carrier frequencies can be approximately calculated by examining the gradient of the phase pattern, or by summing processed Fourier transforms of the phase-shifted images, as described previously, and finding the peaks which correspond to the carrier frequencies.

With the simplest demodulation algorithms, the phase offsets must be an exact amount, such as multiples of 90°, and any error in the specific phase offsets will result in demodulation error. In more complicated algorithms, a high-quality demodulation can be produced given enough phase-shifted images with a well-spread selection of phase offsets if the actual, physical, phase offsets of each image is accurately known.

In the case of X-ray moiré imaging, the features in the X-ray gratings which cause the phase offset are extremely fine, and the physical shift of a grating to cause a specific or introduced phase offset is correspondingly extremely small. For example, a shift of 1μ in a grating will cause a phase offset of approximately 90°. Any error in the physical placement of the grating away from the specific introduced offset will cause an error in the true or actual phase offset, and hence in the demodulation of the image representing the object. Providing a means of accurately measuring the phase offsets, or the errors associated therewith, will result in an improvement in demodulation quality.

It is also possible that there are amplitude variations in each image due to vagaries of the X-ray source used. Providing a means of accurately measuring the X-ray amplitude in each image will result in an improvement of demodulation quality. The measured amplitude of each image can be normalised to a common nominal amplitude before demodulation, thus removing the errors due to amplitude variations. One method to determine the phase offsets and amplitude of each image is to analyse the Fourier Transform of each phase-shifted image.

In the case of general fringe analysis, in each phase-shifted image there will be a central peak at the DC position of each Fourier transform corresponding to the integral of the positive intensity values. The number of carrier frequencies is not limited, and there will also be two positions in the Fourier transform corresponding to each carrier frequency in the image, one for each element in the Hermitian pair.

In an X-ray moiré system, such as the system 799, which consists of two sets of cosine fringes multiplied together and oriented at right angles with respect to each other (these fringes can also be called “crossed fringes”), each Fourier transform of each phase-shifted image is composed of nine modulated frequencies, which will usually form nine discernable peaks in the Fourier domain. There will always be a peak in the centre of the Fourier transform at the DC frequency, because the input signal is strictly positive. There are four frequencies corresponding to the two fringe carrier frequencies and their two Hermitian pairs, being \tilde{F}ₓ, F_{y}, −\tilde{F}ₓ, and −\tilde{F}_{y}, because the signal is real. There are also four signals corresponding to the crossed terms, which are the sum and difference frequencies of the carrier frequencies, and their Hermitian pairs, being (\tilde{F}ₓ+\tilde{F}_{y}), (\tilde{F}ₓ−\tilde{F}_{y}), (−\tilde{F}ₓ+\tilde{F}_{y}), and (−\tilde{F}ₓ−\tilde{F}_{y}).

If each of the nine frequencies is known, then an amplitude and phase value can be approximately determined for each by interpolating the real and imaginary values in each corresponding position in the Fourier transform for each phase-shifted image. Note that because the input images are purely real positive values, the phase of the DC frequency in the Fourier transform will always be zero.

If the carrier frequencies are not known, then they can usually be approximately determined by finding magnitude peaks in the Fourier transform of any one of the phase-shifted images. The carrier frequencies can be determined based on the position of magnitude peaks in the Fourier transform. The determined carrier frequencies correspond to half a wavelength in the spatial domain.

In the X-ray moiré system, the carrier fringes are oriented at right angles to each other, thus to find the carrier frequencies more accurately, two amplitude peaks are found in the Fourier transform which are both at a similar distance from the DC frequency, with near-orthogonal position vectors (here and after near-orthogonal means that angle between directions of carrier fringes is about 90°, for example within ±5°). The position of these peaks can be estimated by any of a number of peak interpolation methods, such as by use of a Chirp-Z transform to interpolate values on close proximity to the peak, followed by a parabolic fit, from whence the complex value of the peak can be measured, and hence its magnitude and phase can be derived from real and imaginary part respectively.

However, as discussed above, there are many sources of error in the measurement of the position, phase and amplitude of the frequencies in phase-shifted images, and the methods and principles described above can be applied to produce a system for accurately estimating carrier frequency of all the images, and amplitude and phase of each carrier frequency in each of the phase-shifted images in an X-ray moiré system.

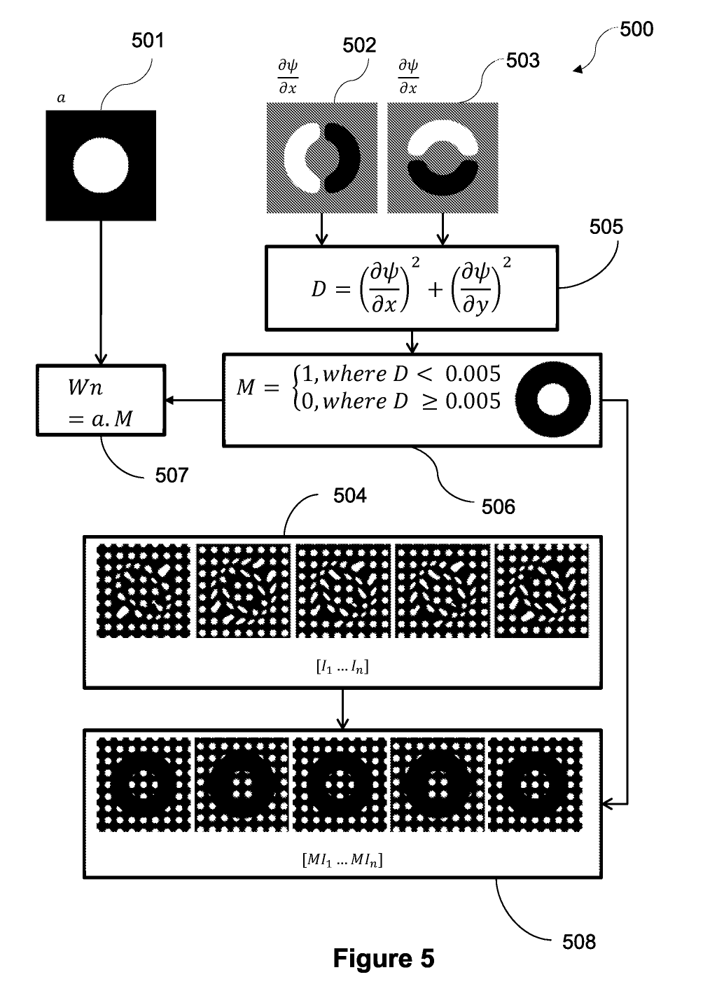

A first system to be described operates in six parts. In the first part, the carrier frequencies are estimated. In the second part, the phase offset and amplitude of each carrier frequency in each input image is estimated. In the third part, a trial demodulation is performed to create an estimate of an image of amplitude and phase. In the fourth part, (seen in FIG. 5) a phase mask is computed which is used to window the input images and assist in the modelling of the complex Fourier peaks representing the phase and amplitude of the carriers in each input image. In the fifth part, the phase offset of each carrier frequency in each image is estimated with the benefit of using the phase mask and the estimated amplitude image. In the sixth and final part, the derived carrier frequencies, and phase and amplitude parameters for each carrier, are passed with each phase-shifted image to a demodulation algorithm to produce a final demodulated image.

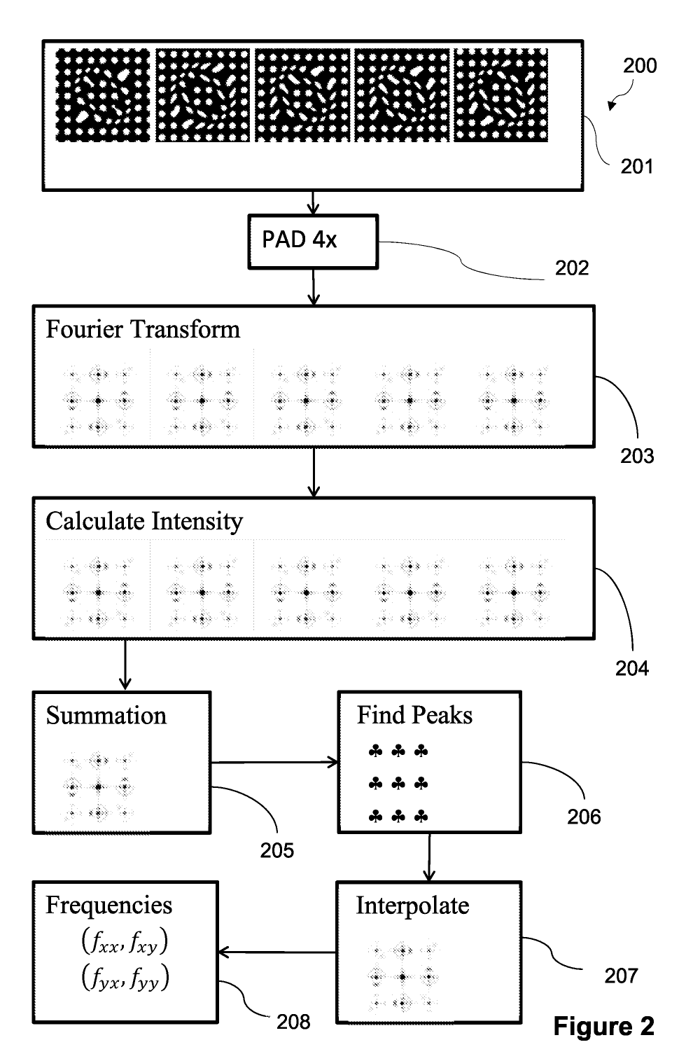

A process 200 to accurately determine carrier frequencies is depicted in FIG. 2. Note that the process 200 is not necessarily required, as the carrier frequencies may already be known because of accurate placing of the gratings, or if the carrier frequencies have already been measured by some other process.

At the beginning of the process 200, in first step 201, n X-ray moiré images, [I₁ . . . Iₙ], are obtained for demodulation, where n≧1. The moiré images, [I₁ . . . Iₙ] contain moiré fringes of the form described by the equation for zᵢ, where the fringes are composed as the product of two cosine functions where the direction of the two cosines are at an angle of 90°. The moiré images, [I₁ . . . Iₙ], are typically obtained by, for example by the X-ray apparatus 799 capturing the images and transferring the corresponding image data to the computer module 701 whereupon the image data comprising the fringes may be stored in the memory 706 or HDD 710. In step 202, each image Iᵢ is padded to quadruple its size with zero values (for example, from a size of 512×512 pixels to 2048×2048 pixels). In step 203, the Fourier transform of these padded images is calculated to yield scaled Fourier transforms [F₁ . . . Fₙ]. The padding in the spatial domain results in a four-times oversampling of the Fourier transform to aid magnitude peak detection and interpolation. In step 204, the intensity of each scaled Fourier transform is calculated, for example using the equation Gᵢ=|Fᵢ×Fᵢ*|. In step 205, multiple images are combined to estimate peak position. Specifically, an element-wise summation of each scaled Fourier transform intensity image is computed to produce an image P containing intensity peaks, P=ΣGᵢ.

Assuming that the modulation and distortion of the carrier frequencies is not too great, meaning that peaks remain discernible, the image P will contain nine discernible amplitude peaks arranged in a 3×3 pattern, with the DC peak at the centre, two (+x, +y) carrier frequency peaks making a right-angle with the DC peak, two Hermitian peaks opposite the carrier frequency peaks, and four cross-term peaks making a square. In step 206 the positions of these peaks are determined by finding N magnitude peaks, (where N is larger than 9, for example, 18), and then finding the specific 9 of those N peaks in the 3×3 pattern, with peak i at position (pᵢₓ, p_{iy}). The peaks are ordered from 1 to 9, with peak 1 corresponding to the x carrier and peak 2 corresponding to the y carrier.

Because the image P has been oversampled by four times, measuring the position of the peaks to the nearest pixel in image P allows measurement of the frequencies to an accuracy of only a quarter of a wavelength. To measure the position of the amplitude peaks more accurately, and hence the carrier frequencies, in step 207, a two-dimensional parabola can be fitted to each of the 3×3 pixel neighbourhoods around each of the 9 peak positions. A position where each parabola attains its maximum is calculated, and this position is used as an interpolated position for each peak and represents a more accurate estimate of the carrier frequency. Note that as the position of the DC peak is fixed, only 8 interpolated peak positions need to be calculated.

In step 208, the peak positions corresponding to the two orthogonal carrier frequencies are determined, to yield a carrier frequency (fₓₓ, f_{xy}) for the x path length derivative, and (f_{yx}, f_{yy}) for the y path-length derivative. Note that (f_{yx}, f_{yy}) approximately equals (f_{xy}, −fₓₓ), but there may be slight differences due to imperfections in the grating manufacturing process.

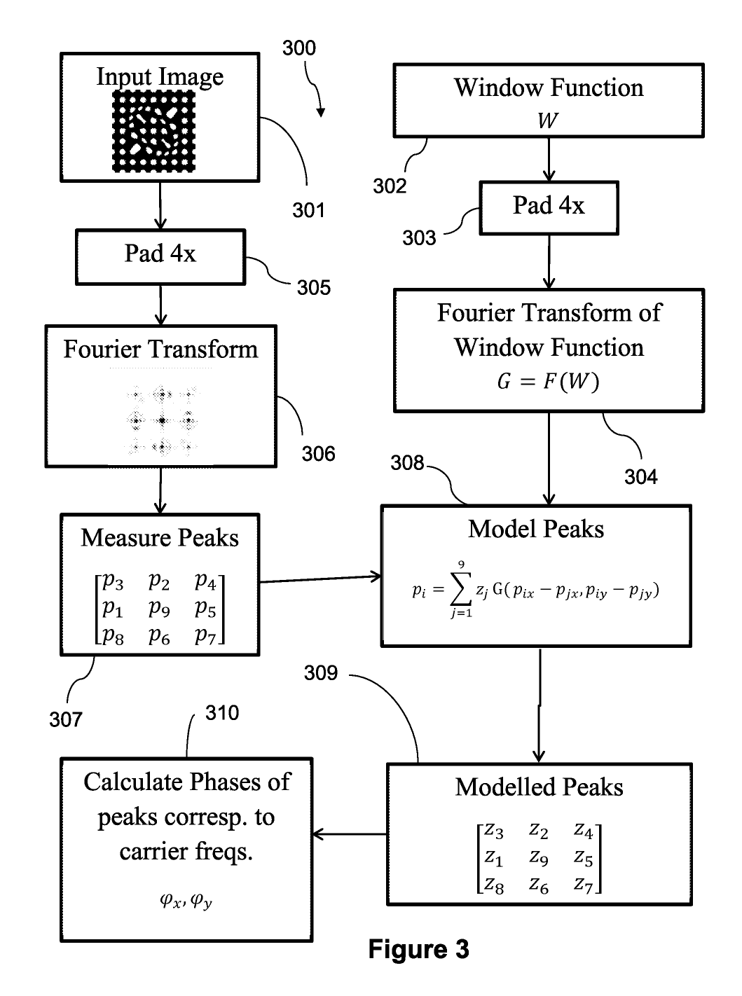

Once the carrier frequencies are determined, they can be used to estimate the phase and amplitude of each of the nine carrier frequencies, according to the method 300 shown in FIG. 3. The method 300 makes used of a window function to create the sidebands around the measured peaks.

The method 300 to estimate the phase offset of fringes takes as input one of the fringe patterns Iᵢ as an input image at step 301, and a window function W, at step 302. The window function W can simply be the rectangular window of the image Iᵢ. Both the input image Iᵢ and the window function W must be the same size.

In step 303, the window function is padded to four times its size (for example, from a size of 512×512 to 2048×2048) by zero filling.

In step 304, the Fourier transform G of the padded windowing function, is calculated. This function models the sidebands around each of the peaks. If the window function is a simple rectangle, then G will be a periodic sinc function.

In step 305, the input image Iᵢ is similarly padded to four times its size by zero-filling.

In step 306, the Fourier transform H of the padded input image is calculated.

The combination of zero-filling the image padded to four times it's size followed by a Fourier transform results in an oversampling of the Fourier transform by four times. Other methods could be used to oversample the Fourier transform, such as interpolation, but the zero padding method is the most accurate.

Note that steps 305 and 306 replicate steps 202 and 203 respectively. Those steps may therefore have been previously performed while determining the frequency. Accordingly where the method 300 follows the method 200, those operations need not be performed a second time. The results of step 203 for example may be retained in the memory 706, 710 and reused in the method 300.

In step 307, the complex values pᵢ at the nine peak positions (pᵢₓ,p_{iy}) calculated in step 206 are interpolated in the Fourier transform image H by a cubic or similar interpolation method to yield complex values [p₁ . . . p₉], as the measured peak values.

In step 308, a system of 9 linear equations is created as described previously using the Fourier transform of the window function, G determined at step 304, to model the interaction of the measured peaks from step 307 upon each other. The modelling of step 308 may be performed according to the equation:

$${p}_{i} = {\sum }_{j = 1}^{9} {z}_{j} G ( {p}_{ix} - {p}_{jx} , {p}_{ij} - {p}_{jy} )$$

Note that the origin of the Fourier transform is the DC position, and, where the coordinates of G are out of range, the usual wrapping toroidal geometry of the Fourier transform is used, i.e. G(x, y)≡G(x mod w, y mod h), where w and h are the respective width and height of G.

This set of equations formed in step 308 may be solved by Gauss-Jordan elimination, or an equivalent method, to yield, in step 309, complex modelled peak values zⱼ.

In step 310, estimates of the fringe phase offsets φₓ and ω_{y} can be determined by calculating φₓ=arg z₁, φ_{y}=arg z₂, using the complex modelled peak values corresponding to the two carrier frequencies (fₓₓ, f_{xy}) and (f_{yx}, f_{yy}) determined in the method 200.

The process described in FIG. 3 can be repeated for each image, yielding {φₓᵢ, φ_{yi}, Iᵢ} and used as input to a phase-shifting algorithm to derive approximate images, being an absorption image, a, and phase images, ωₓ and ω_{y}.

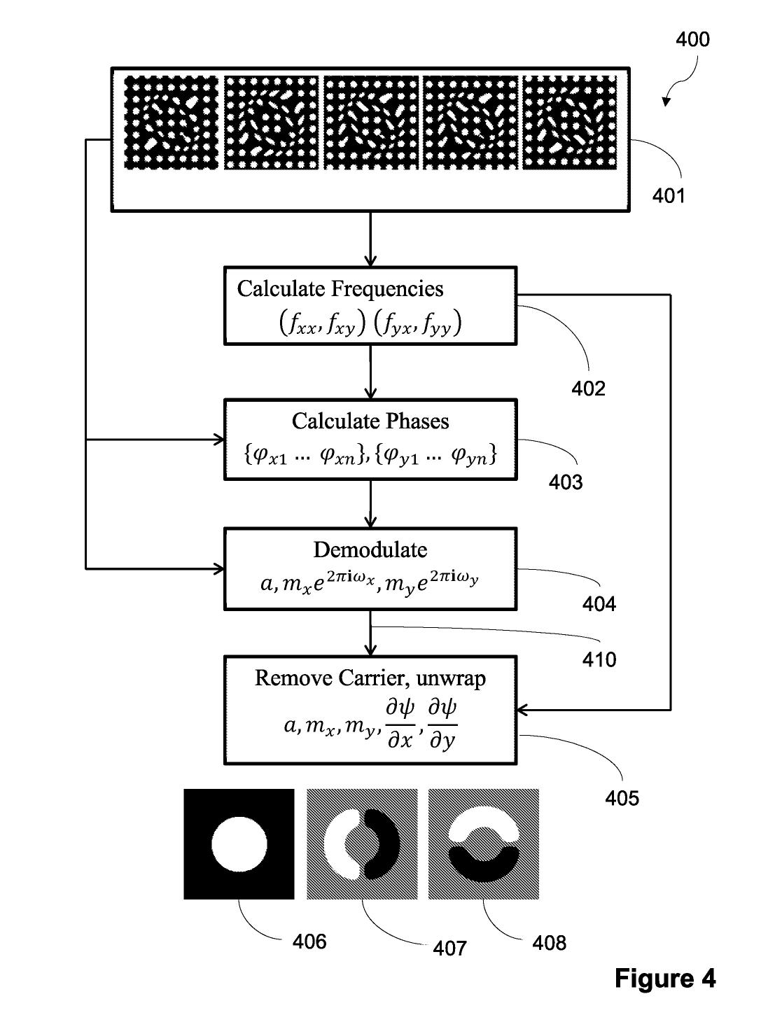

A first demodulation process 400 is shown in FIG. 4.

In step 401, the process 400 takes as input the collection of phase-shifted images [I₁ . . . Iₙ], for example being those used in step 201.

In step 402, the carrier frequencies are estimated by the process shown in FIG. 2.

In step 403, the image phase offsets are estimated by the process shown in FIG. 3.

In step 404, the collection of phase-shifted images from step 401 is combined with the phase offsets determined in step 403 to perform a demodulation to produce a trial demodulated image 410 containing at least the absorption image, a, and the demodulated phase images ωₓ and ω_{y}, of the two carrier frequencies.

Demodulation of step 4040 may be performed using a non-linear solution with separable modulation. For example, Equation (1) can be written more compactly as

zᵢ=Zᵢ(C) (2)

where the vector C represents the parameters to be estimated:

C=[ααₓα_{y}βₓβ_{y}]

and

αₓ=mₓ cos(ωₓ),βₓ=−mₓ sin(ωₓ)

α_{y}=m_{y} cos(ω_{y}),β_{y}=−m_{y} sin(ω_{y}) (3)

It is convenient to define a residual function

$$f ( C ) = [ \begin{matrix}{f}_{0} ( C ) \\ ⋮ \\ {f}_{i} ( C ) \\ ⋮ \\ {f}_{N - 1} ( C )\end{matrix} ] = [ \begin{matrix}{Z}_{0} ( C ) - {z}_{0} \\ ⋮ \\ {Z}_{i} ( C ) - {z}_{i} \\ ⋮ \\ {Z}_{N - 1} ( C ) - {z}_{N - 1}\end{matrix} ] . \qquad ( 4 )$$

In Equation (2), Zᵢ(C) denotes the modeled pixel intensity described by Equation (1) with imposed phase step values (φₓᵢ, φ_{yi}), i=0, . . . , M−1 and zᵢ represents the captured pixel intensity. In order to minimize f(C), Gauss-Newton algorithm is applied to minimize the mean squared residual:

S(C)=f(C)^{T}f(C).

This gives the iterative solution as follows:

Cₖ₊₁=Cₖ−(J^{T}J)⁻¹J^{T}f(C) (5)

where J is the M×5 Jacobian matrix of f(C), i.e.,

$$J = [ {J}_{i} ] , {J}_{i} = \frac{\partial {f}_{n}}{\partial {C}_{i}} ,$$

where i=1, . . . , 5

The columns of J are:

$${J}_{1} = \frac{\partial {f}_{i}}{\partial a} = 1 + {α}_{x} cos ( {ϕ}_{xi} ) + {β}_{x} sin ( {ϕ}_{xi} ) + {α}_{y} cos ( {ϕ}_{yi} ) + {β}_{y} sin ( {ϕ}_{yi} ) + {α}_{x} {α}_{y} cos ( {ϕ}_{yi} ) cos ( {ϕ}_{xi} ) + {β}_{x} {β}_{y} sin ( {ϕ}_{yi} ) sin ( {ϕ}_{xi} ) + {α}_{x} {β}_{y } sin ( {ϕ}_{yi} ) cos ( {ϕ}_{xi} ) + {β}_{x} {α}_{y} cos ( {ϕ}_{yi} ) sin ( {ϕ}_{xi} ) \\ {J}_{2} = \frac{\partial {f}_{i}}{\partial {α}_{x}} = a ( cos ( {ϕ}_{xi} ) + {α}_{y} cos ( {ϕ}_{yi} ) cos ( {ϕ}_{xi} ) + {β}_{y} sin ( {ϕ}_{yi} ) cos ( {ϕ}_{xi} ) ) \\ {J}_{3} = \frac{\partial {f}_{i}}{\partial {α}_{y}} = a ( cos ( {ϕ}_{yi} ) + {α}_{x} cos ( {ϕ}_{yi} ) cos ( {ϕ}_{xi} ) + {β}_{x} sin ( {ϕ}_{yi} ) cos ( {ϕ}_{xi} ) ) \\ {J}_{4} = \frac{\partial {f}_{i}}{\partial {β}_{x}} = a ( sin ( {ϕ}_{xi} ) + {α}_{y} cos ( {ϕ}_{yi} ) sin ( {ϕ}_{xi} ) + {β}_{y} sin ( {ϕ}_{yi} ) sin ( {ϕ}_{xi} ) ) \\ {J}_{5} = \frac{\partial {f}_{i}}{\partial {β}_{y}} = a ( sin ( {ϕ}_{yi} ) + {α}_{x} sin ( {ϕ}_{yi} ) cos ( {ϕ}_{xi} ) + {β}_{x} sin ( {ϕ}_{yi} ) sin ( {ϕ}_{xi} ) ) . \qquad ( 6 )$$

Starting with some initial estimate C₀, the Gauss-Newton method updates the estimate of the parameter vector at each step until the estimate converges (f(Cₖ)<ε, where ε is the acceptable squared residual). This iterative process returns an estimate for the vector of parameters C=[α αₓ α_{y} βₓ β_{y}] from which the phase and amplitude parameters can be recovered as

mₓ=\sqrt{αₓ²+βₓ²}

m_{y}=\sqrt{α_{y}²+β_{y}²}

ωₓ=a tan 2(−βₓ,αₓ)

ω_{y}=a tan 2(−β_{y},α_{y}) (7)

where a tan 2(•,•) is an arctangent function that properly accounts for the sign of the quadrature components αₓ and βₓ.

In step 405, the carrier frequencies are removed from ωₓ and ω_{y} by addition of a linear phase, yielding modulation amplitude images mₓ and m_{y} and the optical path length (phase) derivatives

$$\frac{\partial ψ}{\partial x} , \frac{\partial ψ}{\partial y} ,$$

which might still be in wrapped form, i.e. as only the fractional part of a cycle. The integer part of the optical path length derivatives may be restored by any of the well-known algorithms for phase unwrapping. FIG. 4 illustrates the results of removing the carrier frequencies and of any unwrapping, being the absorption image a, 406, and the optical path length (phase) derivative images

$$\frac{\partial ψ}{\partial x} ,$$

407, and

$$\frac{\partial ψ}{\partial y} ,$$

408 and the modulation amplitude images mₓ and m_{y}.

Because of errors in the estimation of φₓᵢ, φ_{yi}, the trial demodulation will contain errors. To reduce the errors in φₓᵢ, φ_{yi}, the process of FIG. 3 to estimate phase offsets is repeated using a new window function and modified input image.

FIG. 5 shows a process 500 to generate the new window function and to modify the images using an input mask image.

The process 500 uses a number of inputs, being the absorption image a, 501, the optical path length (phase) derivative images

$$\frac{\partial ψ}{\partial x} ,$$

407, and

$$\frac{\partial ψ}{\partial y} ,$$

503, for example obtained at the conclusion of the process 400, and the set of phase-shifted images, I₁ . . . Iₙ, 504, as used in steps 201 and 401.

In step 505, a threshold value image D is computed from the derivative images, according to the equation:

$$D = {( \frac{\partial ψ}{\partial x} )}^{2} + {( \frac{\partial ψ}{\partial y} )}^{2}$$

The threshold value image D represents distortion in the intermediate demodulation image by quantifying the degree of phase modulation across the input phase images 504 (obtained using the method 400). The image D is used to distinguish between highly modulated regions and relatively unmodulated regions. The phase derivative images 502 and 503 are expressed in units of cycles.

In step 506, the mask image M is calculated using the threshold value image D, such that:

$$M = \{ \begin{matrix}1 , & where D < t \\ 0 , & where D \geq t\end{matrix}$$

The mask has a value of 0 in highly modulated areas, and a value of 1 in areas of relatively low modulation. The variable t is selected to remove edge areas and highly modulated regions, and a value of 0.005 has been found by the present inventors to produce an acceptable mask. The mask image M will be used to remove high-modulation areas by multiplying both the images and the window function by the mask to remove these regions from the calculation of phase offsets.

While in the presently described implementation the mask is a binary mask, the mask image may be constructed by other means to contain values between 0 and 1, thus representing a grey-scale mask, and thereby weighting different regions of the image instead of masking them.

In step 507, the new window function Wₙ is created,

Wₙ=a·M

The first part of the new window function, Wₙ, is the absorption image, a, 501, which is used to account for the sidebands resulting from the multiplication of each input image by the absorption function.

The second part of the new window function Wₙ is the mask image M, as determined in step 506. The multiplication by M sets the new window function to be zero in regions corresponding to high modulation areas and removes these areas of the input images from consideration when calculating the phase offsets.

In step 508, a masked set of input images MIᵢ is created by multiplying the original input images Iᵢ by M, which removes the highly modulated areas from the input images, yielding a set of masked input images, M·Iᵢ. The application of the mask in step 508 forms a windowed region in th captured image having a predetermined amount of distortion associated with the distortion value D determined at step 505.

Using this new window function, Wₙ and a masked input image M·Iᵢ, being the outputs of the process 500, the process 300 shown in FIG. 3 can be repeated, using the new window function Wₙ as the input 302, and the masked input image M·Iᵢ as the input 301, to re-estimate phase offset of the masked input image, yielding a new set of phases offsets [φₓ₁′ . . . φₓₙ′] and [φ_{y1}′ . . . φ_{yn}′].

These new phase offsets are an improvement on the initial phase offsets because they incorporate the sidebands for the absorption, and remove the parts of the image containing strongly-modulated phases.

These new phase offsets, together with the original input images {φₓᵢ′, φ_{yi}′, Iᵢ}, or the masked input images, can then be used to repeat the demodulation process with the better estimates, resulting in a second, more accurate, demodulation image.

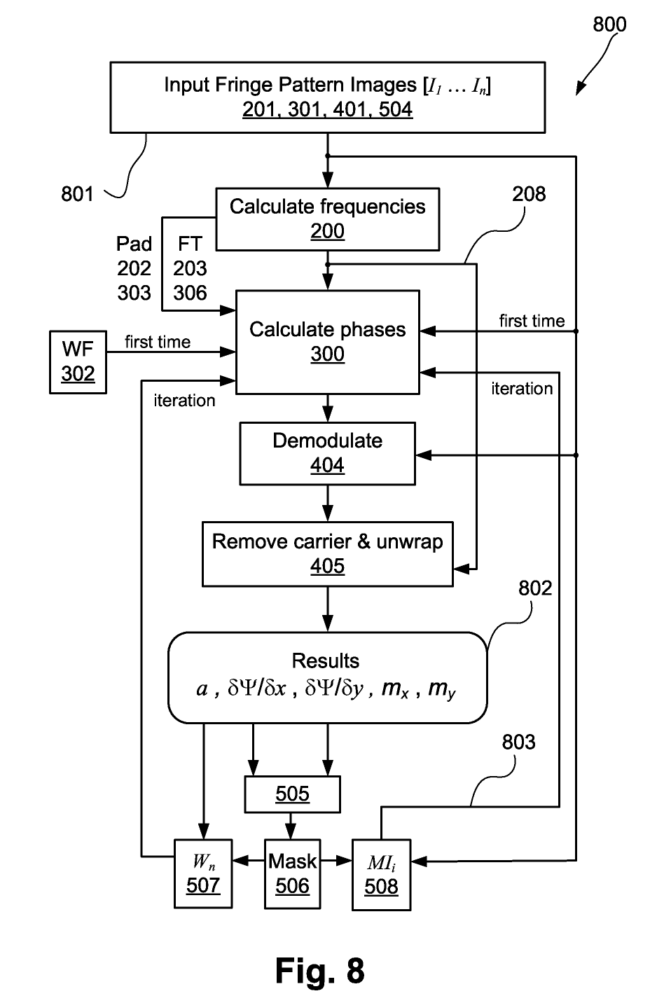

FIG. 8 is a schematic representation depicting how the arrangements of FIGS. 2 to 5 interact to iteratively determine the phase offset in the fringe pattern images in a method 800. The input fringe pattern images 801 are input to each of the calculate carrier frequencies step 200 and the demodulation step 404, and individually initially for the image being processed to the calculate phases step 300. As discussed above, the padded window data and Fourier transformed data from step 200 can be re-used on a first calculation by the calculate phase step 300. For a subsequent iteration, these values are derived from steps 507 and 508 respectively, where step 508 gives a processed captured image 803 which is then iterated in the step 300. The calculated carrier frequencies are used in the remove and unwrap step 405 to reveal the results 802 of the method being improved determination of the phase offsets in the fringe pattern of an image in question.

### Example 2

In alternative implementations, for example when carrier frequencies are unknown and modulation threshold exceeds a predetermined value, extra images which do not contain an object between the X-ray source and the sensor can be captured and used to determine carrier frequencies and phases. Once this process is complete, the previously described method, to measure the carrier frequencies, can be applied.

In the case where the carrier frequencies are precisely known, then an accurate estimate of each phase in each image can be made by using the previously described method of carrier compression.

This method requires a trial demodulation image, such as the image 410, containing an initial estimate of absorption and the phase corresponding to each carrier frequency. To calculate a trial demodulation image, the phase-stepped images must be captured with known nominal phases.

We now show how the method of carrier compression can be used to estimate carrier frequency and phase offset in the X-ray Talbot system 799 in which there are two carrier frequencies and phase offsets per image, one for the x path-length derivative, and one for the y path-length derivative.

One set of nominal phases in the X-ray Talbot system which gives good results, requires eight images A . . . H to be taken, with each image containing different nominal phase offsets and all nominal phases being multiples of 90°. An example of those relationships is shown in the following table:

y

| x | 0° | 90° | 180° | 270° |
|---|---|---|---|---|
| 0° | A | | B | |
| 90° | | C | | D |
| 180° | E | | F | |
| 270° | | G | | H |

This arrangement provides a simple and reasonably accurate demodulation, assuming that the nominal phase steps are accurate to within about 10°:

$$a = \frac{A + B + C + D + E + F + G + H}{2}$$

$${m}_{x} {e}^{i {ω}_{x}} = \frac{( A - B + E - F ) + i ( C - D + G - H )}{4 a}$$

$${m}_{y} {e}^{i {ω}_{y}} = \frac{( A - E + B - F ) + i ( C - G + D - H )}{4 a}$$

There are many other arrangements of phase offsets and calculations for producing such demodulations, but the 8-step chequerboard arrangement shown here is a good method.

To accurately measure the actual phase offsets of one of the phase-stepped images [A . . . F], each phase-stepped image can be multiplied by the estimated phase to demodulate the phase to the DC position of the Fourier Transform, from whence the phase offset can be measured. The DC value of the Fourier Transform is equivalent to calculating the mean value of the image, thus, for a phase-stepped image Iᵢ, the relative phase offset can be calculated using this method:

φᵢₓ=arg(mean(Iᵢ·e^{-ω}^{ₓ}))

φ_{iy}=arg(mean(Iᵢ·e^{-ω}^{_{y}}))

In this example, each phase offset is calculated as the phase of the weighted mean value of many complex vectors weighted by the absorption and modulation parameters.

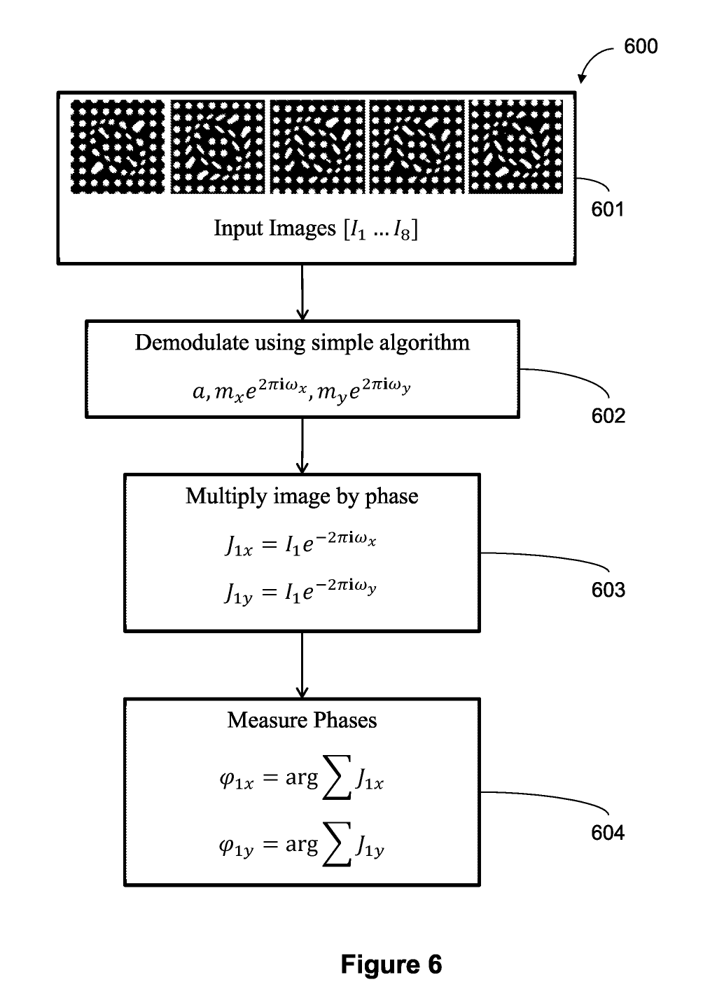

FIG. 6 shows a process 600 of determining the phase offsets of one image using this method.

The input 601 to the process 600, is eight phase-shifted images [I₁ . . . I₈], with phase offsets approximately equal to those shown in the table above.

In step 602, the input images are demodulated using the known phases to yield an approximate demodulated output, a, mₓe^{iω}^{ₓ}, m_{y}e^{iω}^{_{y}}.

In step 603, the first image in the input set, I₁, is multiplied by the estimated phases for x and y to yield images with each carrier compressed to the DC frequency,

J₁ₓ=I₁e^{-iω}^{ₓ}

J_{1y}=I₁e^{-iω}^{_{y}}

In step 604, the phase offset for I₁ for x and y is determined by calculating the phase of the pixelwise summation of the images J₁ₓ and J_{1y},

$${ϕ}_{1 x} = arg {\sum }_{pixels} {J}_{1 x}$$

$${ϕ}_{1 y} = arg {\sum }_{pixels} {J}_{1 y}$$

If the carrier frequencies are well-known before the image I₁ is captured, then it is not necessary to execute the steps required to determine them. The process of FIG. 6 can then be repeated for each of the captured images to determine the phase offsets for each image.

### CONCLUSION

The various arrangements described above provide for the determining at least one phase offset of a fringe pattern in a captured image 401 having a phase modulated fringe pattern. This may be done by forming an intermediate demodulation image 410 from the captured image using for example steps 401, 402 (being the method 200), 403 (the method 300) and step 404. The intermediate demodulation image defines amplitude and complex phase parameters of the phase modulated fringe pattern. The captured image is also transformed (508) by a mask (M) 506 to produce a processed captured image (M·I₁) having reduced effects of phase distortion. The mask (M) is preferably estimated from a function (405) of the amplitude (a) and/or complex phase parameters

$$\frac{\partial ψ}{\partial x} , \frac{\partial ψ}{\partial y} ,$$

defined by the intermediate demodulation image. A Fourier transform of the processed captured image (803) is then determined (306) and at least one phase offset [φₓ₁′ . . . φₓₙ′] and [φ_{y1}′ . . . φ_{yn}′] of the fringe pattern is determined in the processed captured image using the mask, which for example provides a (new) window function (302), to identify an interaction (308, 309) of peaks in the Fourier transform.

In respect of the second example, approximated demodulation using known phase permits the estimated phase images multiplied with the input image to compress the carrier to the DC frequency. Pixel-wise summation of the compressed orthogonal images provides for calculation the unknown phase offset.

This iterative approach makes use of the Fourier transform to form initial estimates of the phases, and then, with window and mask functions, to iterate at least one refinement of the phases again using the Fourier transform. This approach provides for reasonable accuracy whilst optimising calculations using the relatively easily applied Fourier transform, or partial calculation thereof, and the identification of peaks arising therefrom.

### INDUSTRIAL APPLICABILITY

The arrangements described are applicable to the computer and data processing industries and particularly for the processing of X-ray images for the recovery of phase information. This can be useful in soft tissue analysis or material structural analysis. The arrangements are not limited to X-ray Talbot imaging but may be used for other purposes. For example the arrangements described may operate in the visible spectra, such as for measuring the spatial distortion of optical lenses, this being relevant to lens and camera manufacture. Another application is in the area of sonar and audible spectra where sound waves can be processed.

The foregoing describes only some embodiments of the present invention, and modifications and/or changes can be made thereto without departing from the scope and spirit of the invention, the embodiments being illustrative and not restrictive.

1. A method of determining at least one actual phase offset of a fringe pattern in a captured image, said method comprising:
receiving a captured image having a phase modulated fringe pattern, the captured image being one of a set of images captured with varying introduced phase offset;
forming an intermediate demodulation image from the captured image, said intermediate demodulation image defining amplitude and complex phase parameters of the phase modulated fringe pattern;
transforming the captured image by a mask to produce a processed captured image having reduced effects of phase distortion, said mask being estimated from a function of at least one of the amplitude and complex phase parameters defined by the intermediate demodulation image;
determining a Fourier transform of the processed captured image; and
determining at least one phase offset of the fringe pattern in the processed captured image using the mask to identify interaction of peaks in the Fourier transform.

2. A method according to claim 1, wherein the determining of the at least one phase offset further comprises measuring peaks in the Fourier domain.

3. A method according to claim 1 further comprising combining multiple images to estimate the peak position.

4. A method according to claim 3, wherein the combining comprises element-wise summation of a plurality of Fourier transform images to form an image containing intensity peaks.

5. A method according to claim 1 wherein the mask is a binary mask.

6. A method according to claim 1, wherein the mask is a grey-scale mask.

7. A method according to claim 1, wherein forming an intermediate demodulation image from the set of images captured with varying introduced phase offset further comprises:
(a) determining an estimate of the amplitude and complex phase parameters using the received set of the images captured with varying introduced phase offset;
(b) reconstructing the intermediate demodulation image using the determined estimate of the amplitude and complex phase parameters to minimise a residual function, wherein the residual function is determined based on a modelled pixel intensity and a captured pixel intensity; and
(c) repeating (a) and (b) until the residual function meets pre-determined criteria.

8. A method according to claim 1, wherein forming an intermediate demodulation image from the set of images captured with varying introduced phase offset further comprises:
obtaining an initial estimate of the amplitude and complex phase parameters of the phase modulated fringe pattern;
using a phase estimation method to correct phase step errors in the parameters; and
iteratively determining a solution for the parameters using the corrected phase steps.

9. A method of determining at least one phase offset of a fringe pattern in a captured image, said method comprising the steps of:
receiving a captured image of a phase modulated fringe pattern, the captured image being one of a set of images captured with varying introduced phase offset;
forming an intermediate demodulation image from the captured image, said intermediate demodulation image defining amplitude and complex phase parameters of the phase modulated fringe pattern;
measuring the distortion for a plurality of locations in the intermediate demodulation image;
applying a phase mask to the captured image based on the measured distortion, said phase mask defining a windowed region in the captured image having a predetermined amount of distortion; and
determining at least one phase offset of the fringe pattern in the windowed region of the captured image.

10. A method of determining at least one actual phase offset of a fringe pattern in a captured image, said method comprising:
(a) receiving a captured image having a phase modulated fringe pattern, the captured image being one of a set of images captured with varying introduced phase offset;
(b) calculating carrier frequencies of the fringe pattern;
(c) calculating, using a Fourier transform of the captured image and a window function, phases of the captured image;
(d) demodulating from the calculated phases an intermediate demodulation image from the captured image, said intermediate demodulation image defining amplitude and complex phase parameters of the phase modulated fringe pattern including at least a phase offset value;
(e) transforming the intermediate modulation image by a mask to produce a processed captured image having reduced effects of phase distortion, said mask being estimated from a function of at least one of the amplitude and complex phase parameters defined by the intermediate demodulation image;
(f) updating the window function according to the mask; and
(g) repeating at least steps (c) and (d) at least once with the updated window function and the processed captured image to iterate a further intermediate demodulation image having an updated phase offset value, said updated phase offset value being the actual phase offset.

11. A computer readable storage medium having a program recorded thereon, the program being executable by a computer to determine at least one actual phase offset of a fringe pattern in a captured image by performing the steps of:
receiving a captured image having a phase modulated fringe pattern, the captured image being one of a set of images captured with varying introduced phase offset;
forming an intermediate demodulation image from the captured image, said intermediate demodulation image defining amplitude and complex phase parameters of the phase modulated fringe pattern;
transforming the captured image by a mask to produce a processed captured image having reduced effects of phase distortion, said mask being estimated from a function of at least one of the amplitude and complex phase parameters defined by the intermediate demodulation image;
determining a Fourier transform of the processed captured image; and
determining at least one phase offset of the fringe pattern in the processed captured image using the mask to identify interaction of peaks in the Fourier transform.

12. A computer readable storage medium according to claim 11, wherein forming an intermediate demodulation image from the set of images captured with varying introduced phase offset further comprises:
(a) determining an estimate of the amplitude and complex phase parameters using the received set of the images captured with varying introduced phase offset;
(b) reconstructing the intermediate demodulation image using the determined estimate of the amplitude and complex phase parameters to minimise a residual function, wherein the residual function is determined based on a modelled pixel intensity and a captured pixel intensity; and
(c) repeating (a) and (b) until the residual function meets pre-determined criteria.

13. A computer readable storage medium according to claim 11, wherein forming an intermediate demodulation image from the set of images captured with varying introduced phase offset further comprises:
obtaining an initial estimate of the amplitude and complex phase parameters of the phase modulated fringe pattern;
using a phase estimation method to correct phase step errors in the parameters; and
iteratively determining a solution for the parameters using the corrected phase steps.

14. A computer readable storage medium having a program recorded thereon, the program being executable by a computer to determine at least one actual phase offset of a fringe pattern in a captured image by performing the steps of:
receiving a captured image of a phase modulated fringe pattern, the captured image being one of a set of images captured with varying introduced phase offset;
forming an intermediate demodulation image from the captured image, said intermediate demodulation image defining amplitude and complex phase parameters of the phase modulated fringe pattern;
measuring the distortion for a plurality of locations in the intermediate demodulation image;
applying a phase mask to the captured image based on the measured distortion, said phase mask defining a windowed region in the captured image having a predetermined amount of distortion; and
determining at least one phase offset of the fringe pattern in the windowed region of the captured image.

15. A computer readable storage medium having a program recorded thereon, the program being executable by a computer to determine at least one actual phase offset of a fringe pattern in a captured image by performing the steps of:
(a) receiving a captured image having a phase modulated fringe pattern, the captured image being one of a set of images captured with varying introduced phase offset;
(b) calculating carrier frequencies of the fringe pattern;
(c) calculating, using a Fourier transform of the captured image and a window function, phases of the captured image;
(d) demodulating from the calculated phases an intermediate demodulation image from the captured image, said intermediate demodulation image defining amplitude and complex phase parameters of the phase modulated fringe pattern including at least a phase offset value;
(e) transforming the intermediate modulation image by a mask to produce a processed captured image having reduced effects of phase distortion, said mask being estimated from a function of at least one of the amplitude and complex phase parameters defined by the intermediate demodulation image;
(f) updating the window function according to the mask; and
(g) repeating at least steps (c) and (d) at least once with the updated window function and the processed captured image to iterate a further intermediate demodulation image having an updated phase offset value, said updated phase offset value being the actual phase offset.

16. Imaging apparatus configured to determine at least one actual phase offset of a fringe pattern in a captured image, the apparatus comprising:
means for receiving a captured image having a phase modulated fringe pattern, the captured image being one of a set of images captured with varying introduced phase offset;
means for forming an intermediate demodulation image from the captured image, said intermediate demodulation image defining amplitude and complex phase parameters of the phase modulated fringe pattern;
means for transforming the captured image by a mask to produce a processed captured image having reduced effects of phase distortion, said mask being estimated from a function of at least one of the amplitude and complex phase parameters defined by the intermediate demodulation image;
means for determining a Fourier transform of the processed captured image; and
means determining at least one phase offset of the fringe pattern in the processed captured image using the mask to identify interaction of peaks in the Fourier transform.

17. An apparatus according to claim 16, wherein said means for forming an intermediate demodulation image from the set of images captured with varying introduced phase offset comprises:
means for determining an estimate of the amplitude and complex phase parameters using the received set of the images captured with varying introduced phase offset;
means for reconstructing the intermediate demodulation image using the determined estimate of the amplitude and complex phase parameters to minimise a residual function, wherein the residual function is determined based on a modelled pixel intensity and a captured pixel intensity; and
means for repeating said determining and said reconstructing until the residual function meets pre-determined criteria.

18. An apparatus according to claim 16, wherein said means for forming an intermediate demodulation image from the set of images captured with varying introduced phase offset comprises:
means for obtaining an initial estimate of the amplitude and complex phase parameters of the phase modulated fringe pattern;
means for using a phase estimation method to correct phase step errors in the parameters; and
means for iteratively determining a solution for the parameters using the corrected phase steps.

19. Imaging apparatus configured to determine at least one actual phase offset of a fringe pattern in a captured image, the apparatus comprising:
means for receiving a captured image of a phase modulated fringe pattern, the captured image being one of a set of images captured with varying introduced phase offset;
means for forming an intermediate demodulation image from the captured image, said intermediate demodulation image defining amplitude and complex phase parameters of the phase modulated fringe pattern;
means for measuring the distortion for a plurality of locations in the intermediate demodulation image;
means for applying a phase mask to the captured image based on the measured distortion, said phase mask defining a windowed region in the captured image having a predetermined amount of distortion; and
means for determining at least one phase offset of the fringe pattern in the windowed region of the captured image.

20. Imaging apparatus configured to determine at least one actual phase offset of a fringe pattern in a captured image, the apparatus comprising:
(a) means for receiving a captured image having a phase modulated fringe pattern, the captured image being one of a set of images captured with varying introduced phase offset;
(b) means calculating carrier frequencies of the fringe pattern;
(c) means for calculating, using a Fourier transform of the captured image and a window function, phases of the captured image;
(d) means for demodulating from the calculated phases an intermediate demodulation image from the captured image, said intermediate demodulation image defining amplitude and complex phase parameters of the phase modulated fringe pattern including at least a phase offset value;
(e) means for transforming the intermediate modulation image by a mask to produce a processed captured image having reduced effects of phase distortion, said mask being estimated from a function of at least one of the amplitude and complex phase parameters defined by the intermediate demodulation image; and
(f) means for updating the window function according to the mask, wherein the processed captured image and the updated window function are used by means (c) and (d) at least once to iterate a further intermediate demodulation image having an updated phase offset value, said updated phase offset value being the actual phase offset.
